(19) United States
(12) Patent Application Publication
(10) Pub. No.: US 2003/0076979 A1
(43) Pub. Date: Apr. 24, 2003

(54) Method of embedding digital watermark, method of extracting embedded digital watermark and apparatuses for the same

(75) Inventor: Kineo Matsui, Yokosuka-shi (JP)

Correspondence Address: BEYER WEAVER & THOMAS LLP, P.O. BOX 778, BERKELEY, CA, 94704-0778, US

(73) Assignee: KOWA CO., LTD.

(21) Appl. No.: 10/191,773

(22) Filed: Jul. 8, 2002

(30) Foreign Application Priority Data
Jul. 10, 2001 (JP) 2001-209496(P)

(51) Int. Cl. G06K 9/00

(52) U.S. Cl. 382/100

(57) ABSTRACT

A color conversion module 42 carries out color conversion of original color image data G_{rgb} from the RGB color system into the CMYK color system to obtain color-converted original color image data G_{cmyk} (step S104). A DCT module 44 applies DCT (discrete cosine transform) over the whole color-converted original color image data G_{cmyk} to generate DCT coefficients D_{cmyk} (step S106). An embedding module 46 embeds the watermark information s into the components C, M, Y, and K of the DCT coefficients D_{cmyk} (step S108). An IDCT module 48 applies IDCT (inverse discrete cosine transform) onto DCT coefficients D′_{cmyk} with the watermark information s embedded therein to generate embedding-processed color image data G′_{cmyk} (step S110). The color conversion module 42 carries out color conversion of the embedding-processed color image data G′_{cmyk} from the CMYK color system into the RGB color system to obtain embedding-processed color image data G′_{rgb} (step S112). This arrangement does not require any correction of the position or the shape of image blocks in the process of extracting the embedded watermark information.

### BACKGROUND OF THE INVENTION

1. Field of the Invention

The present invention relates to a technique of embedding digital watermark in image data and extracting embedded digital watermark.

2. Description of the Related Art

With advancement of computer networks including the Internet, digitalization of information becomes common and allows lots of users to readily access required information. In this environment, copyright infringement is a problem of significant importance. Data of a digital content with copyright can readily be copied and duplicated illegally without any permission of a copyright holder. Such illegal copies infringe the copyright. With a view to preventing the copyright infringement with regard to images, which are primary information of digital contents, digital watermarking techniques have been proposed to embed watermark information, such as copyright information, in image data.

The images include natural images, moving images, and line work images like cartoons. No digital watermarking technique suitable for line work images like cartoons has been proposed so far.

### SUMMARY OF THE INVENTION

The object of the present invention is thus to solve the drawbacks of the prior art technique and to provide a digital watermarking technique suitable for line work images like cartoons.

In order to attain at least part of the above and the other related objects, the present invention is directed to a digital watermark embedding method for embedding watermark information in image data. The digital watermark embedding method includes the steps of: (a) dividing the image data into multiple blocks, where each of the multiple blocks includes at least one pixel; (b) computing a number of specific pixels that have a specific value fulfilling a predetermined condition, out of all pixels included in each of the multiple blocks; (c) making the computed number of specific pixels subjected to a preset operation; and (d) changing the specific value of at least one pixel included in each block in such a manner that a resulting value obtained by the preset operation satisfies a certain condition corresponding to a piece of information to be embedded in the block, among a plurality of conditions set in advance in mapping to the watermark information.

The digital watermark embedding method of the present invention computes the number of specific pixels having a specific value fulfilling a predetermined condition out of all the pixels included in a block of interest, makes the computed number of specific pixels subjected to a preset operation, and changes the specific value allocated to part of pixels in the block of interest, so that the resulting value of the preset operation satisfies a certain condition corresponding to a piece of information to be embedded. In the block of interest, changing the specific value allocated to the part of pixels varies the number of specific pixels fulfilling the predetermined condition, and causes the resulting value of the preset operation to satisfy the certain condition corresponding to the piece of information to be embedded. The information is accordingly embedded in the block of interest.

The digital watermark embedding method of the present invention regulates a distribution of the number of specific pixels fulfilling the predetermined condition, that is, an area (planar extension) distribution, so as to embed watermark information.

The digital watermark embedding method of the present invention embeds watermark information, such as copyright information, in an image without significantly affecting the picture quality and the visual effect of the image, while ensuring a relatively high resistance to diverse attacks. The area (number of pixels) distribution is utilized for embedding the watermark information. This technique regards a line segment or each section of a drawing as an area in the process of embedding watermark information. The digital watermarking technique of the invention is thus suitable for line work images like cartoons.

In the specification hereof, the concept ‘value’ in the term of ‘the specific value of the pixel’ includes both a scalar and a vector.

In one preferable application of the present invention, the digital watermark embedding method further includes the step of: (e) determining whether or not the watermark information is to be embedded in each block, based on the computed number of specific pixels. The steps (c) and (d) are executed for only a block determined in the step (e) that the watermark information is to be embedded.

The previous determination of whether or not the watermark information is to be embedded in each block desirably enables any block that may cause deterioration of the picture quality due to embedding of watermark information to be omitted from the object of embedding the watermark information.

In another preferable application of the digital watermark embedding method of the present invention, the watermark information is expressed by at least a binary value including a first value and a second value. The step (d) changes the specific value of the pixel, when the piece of information to be embedded in the block is the first value, to satisfy such a condition that the resulting value of the preset operation is in a first range as the certain condition corresponding to the first value and, when the piece of information to be embedded in the block is the second value, to satisfy such a condition that the resulting value of the preset operation is in a second range, which is different from the first range, as the certain condition corresponding to the second value.

Setting the condition that the resulting value of the preset operation is in the first range or in the second range according to the piece of information to be embedded enables the embedded watermark information to be extracted more readily and accurately.

In the above application of the digital watermark embedding method of the present invention, it is preferable that the step (d) includes the step of generating a random value. In this arrangement, the step (d) changes the specific value of the pixel, when the piece of information is the first value, to make the resulting value of the preset operation equal to a value corresponding to the random value among values included in the first range and, when the piece of information is the second value, to make the resulting value of the preset operation equal to a value corresponding to the random value among values included in the second range.

Changing the specific value of the pixel to make a random distribution of the resulting value of the preset operation in the first range or in the second range attains a non-localized dispersion of pixels in the processed block. This arrangement desirably prevents any third person from cracking the embedded digital watermark.

In the above application of the digital watermark embedding method of the present invention, it is preferable that the step (d) changes the specific value of the pixel, when the piece of information is the first value, to make the resulting value of the preset operation equal to a third value included in the first range and, when the piece of information is the second value, to make the resulting value of the preset operation equal to a fourth value included in the second range. Changing the specific value of the pixel to fix the resulting value of the preset operation in the first range or in the second range facilitates the process of embedding the watermark information.

In accordance with one preferable application of the digital watermark embedding method of the present invention, when the image data is binary image data including a pixel value expressed by either one of a fifth value and a sixth value, the pixel value is used for the specific value of the pixel, and the step (b) computes the number of specific pixels fulfilling the predetermined condition that the pixel value is equal to the fifth value.

In accordance with another preferable application of the digital watermark embedding method of the present invention, when the image data is color image data, the specific value of the pixel is a value of a luminance component of the pixel, and the step (b) computes the number of specific pixels fulfilling the predetermined condition that the value of the luminance component of the pixel is in a preset third range.

In accordance with still another preferable application of the digital watermark embedding method of the present invention, when the image data is color image data, the specific value of the pixel is a color vector of the pixel, and the step (b) computes the number of specific pixels fulfilling the predetermined condition that the color vector is a specified color vector.

In the above application of the digital watermark embedding method of the present invention, it is preferable that the step (b) varies at random the specific color vector as the predetermined condition for each of the multiple blocks.

In accordance with another preferable application of the digital watermark embedding method of the present invention, when the image data is multi-valued image data, the specific value of the pixel is a certain bit value in a pixel value, and the step (b) computes the number of specific pixels fulfilling the predetermined condition that the certain bit value is equal to ‘1’ or the number of specific pixels fulfilling the predetermined condition that the certain bit value is equal to ‘0’.

Application of an appropriate value for the specific value of the pixel according to the type of image data (the binary image, the color image, or the multi-valued image) enables the watermark information suitable for the characteristics of the type of image data to be embedded.

The present invention is also directed to a digital watermark extraction method for extracting embedded watermark information from image data. The digital watermark extraction method includes the steps of: (a) dividing the image data into multiple blocks, where each of the multiple blocks includes at least one pixel; (b) computing a number of specific pixels that have a specific value fulfilling a predetermined condition, out of all pixels included in each of the multiple blocks; (c) making the computed number of specific pixels subjected to a preset operation; and (d) determining which of a plurality of conditions set in advance in mapping to the watermark information is satisfied by a resulting value of the preset operation, and specifying a piece of information corresponding to the satisfied condition as the watermark information embedded in the block.

The digital watermark extraction method of the present invention computes the number of specific pixels having a specific value fulfilling a predetermined condition out of all the pixels included in a pixel of interest, makes the computed number of specific pixels subjected to a preset operation, determines which of the conditions is satisfied by the resulting value of the preset operation, and specifies a piece of information corresponding to the satisfied condition as the embedded information.

The digital watermark extraction method of the present invention thus enables the embedded watermark information to be readily extracted from the image data by utilizing an area (number of pixels) distribution.

The technique of the present invention is not restricted to the digital watermark embedding method or the digital watermark extraction method described above, but may be actualized by a diversity of other applications including a digital watermark embedding apparatus, a digital watermark extraction apparatus, computer programs for attaining any of such methods and apparatuses, recording media in which such computer programs are recorded, and data signals that include such computer programs and are embodied in carrier signals.

### BRIEF DESCRIPTION OF THE DRAWINGS

FIG. 1 is a block diagram illustrating the construction of a digital watermarking apparatus 10 that carries out a digital watermark embedding process and a digital watermark extraction process of the present invention;

FIG. 2 is a flowchart showing a routine of the digital watermark embedding process executed in a first embodiment of the present invention;

FIG. 3 shows changes of a residue bᵢ according to watermark information;

FIG. 4 is a flowchart showing a routine of the digital watermark extraction process executed in the first embodiment of the present invention;

FIG. 5 is a flowchart showing a routine of the digital watermark embedding process executed in a second embodiment of the present invention;

FIG. 6 shows binary images in which watermark information is embedded;

FIG. 7 shows the number of black pixels plotted against the size of each block and distributions of the frequency of appearance of black pixels;

FIG. 8 shows the number of embeddable blocks plotted against the size of each block with regard to diverse reference values p as a parameter;

FIG. 9 shows a distribution of the frequency of appearance of black pixels in the binary image of Case 2;

FIG. 10 shows images obtained by embedding watermark information into the binary images of Case 1 and Case 2 at a reference value p=128 according to the digital watermark embedding process of the first embodiment;

FIG. 11 shows images obtained by embedding watermark information into the binary images of Case 1 and Case 2 at a reference value p=256 according to the digital watermark embedding process of the first embodiment;

FIG. 12 shows the quantity of embeddable information in the case of embedding watermark information into the binary images of Cases 1 and 2 at the reference values p=128 and p=256;

FIG. 13 shows images obtained by embedding watermark information into the binary images of Case 1 and Case 2 at the reference value p=128 according to the digital watermark embedding process of the second embodiment;

FIG. 14 shows a differential image between the original image of FIG. 6(a) and the information-embedded image of FIG. 10(a);

FIG. 15 shows a result of a StirMark attack to the information-embedded image of FIG. 10(a) and a differential image between the image after the StirMark attack and the information-embedded image of FIG. 10(a);

FIG. 16 shows the relationship between the variation of black pixels and the extracted data;

FIG. 17 shows extraction rates of watermark information at various magnifications in the information-embedded image of FIG. 10(a);

FIG. 18 shows extraction rates of watermark information at various magnifications in the information-embedded image of FIG. 13(a);

FIG. 19 is a flowchart showing a routine of the digital watermark embedding process executed in a third embodiment of the present invention;

FIG. 20 is a flowchart showing a routine of the digital watermark extraction process executed in the third embodiment of the present invention;

FIG. 21 shows a color image in which watermark information is embedded;

FIG. 22 shows an image with only luminance component generated from the color image of FIG. 21 and a frequency distribution of the luminance component in the image;

FIG. 23 shows an information-embedded image and a frequency distribution of the luminance component in the image;

FIG. 24 shows a differential image between the color image of FIG. 21 and the information-embedded image of FIG. 23(a);

FIG. 25 shows a frequency distribution of the number of low luminance pixels in the color image of FIG. 21;

FIG. 26 shows the number of embeddable blocks plotted against the size of each block with regard to diverse reference values p as a parameter;

FIG. 27 shows an information-embedded image with a varied reference value p=256 and a differential image between the information-embedded image and the original image;

FIG. 28 is a flowchart showing a routine of the digital watermark embedding process executed in a fourth embodiment of the present invention;

FIG. 29 is a flowchart showing a routine of the digital watermark extraction process executed in the fourth embodiment of the present invention;

FIG. 30 is a flowchart showing a modified digital watermark embedding process in a modified example of the fourth embodiment;

FIG. 31 shows a color image in which watermark information is embedded;

FIG. 32 shows a color map of the color image shown in FIG. 31;

FIG. 33 shows information-embedded images obtained by embedding watermark information into the color image of FIG. 31;

FIG. 34 shows differential images between the color image of FIG. 31 and the information-embedded images of FIG. 33;

FIG. 35 shows the quantity of embeddable information into the image area of each color vector in the color image of FIG. 31;

FIG. 36 shows an information-embedded image obtained by varying the specified color vector at random and embedding watermark information into the color image of FIG. 31;

FIG. 37 shows a differential image between the color image of FIG. 31 and the information-embedded image of FIG. 36;

FIG. 38 shows a color image after JPEG compression and decompression and a differential image between the color image after the JPEG compression and decompression and the original image;

FIG. 39 shows a color image after color subtraction and a differential image between the color image after color subtraction and the original image;

FIG. 40 shows a color image after a StirMark attack and a differential image between the color image after the StirMark attack and the original image;

FIG. 41 shows a color image after a color subtraction process and a differential image between the color image after the color subtraction process and the original image;

FIG. 42 is a flowchart showing a routine of the digital watermark embedding process executed in a fifth embodiment of the present invention;

FIG. 43 shows four bit planes generated from 4-bit multi-valued image data; and

FIG. 44 is a flowchart showing a routine of the digital watermark extraction process executed in the fifth embodiment of the present invention.

### DESCRIPTION OF THE PREFERRED EMBODIMENTS

Some modes of carrying out the invention are discussed below in the following sequence as preferred embodiments:

A. Construction of Apparatus

B. First Embodiment

B-1. Digital Watermark Embedding Process

B-2. Digital Watermark Extraction Process

C. Second Embodiment

C-1. Digital Watermark Embedding Process

C-2. First Modification of Digital Watermark Embedding Process

C-3. Second Modification of Digital Watermark Embedding Process

C-4. Third Modification of Digital Watermark Embedding Process

C-5. Fourth Modification of Digital Watermark Embedding Process

C-6. Digital Watermark Extraction Process

D. Concrete Examples and Summary of First and Second Embodiments

D-1. Quantity of Embeddable Information

D-2. Complexity of Image and Effects of Embedding

D-3. Resistance to Attacks

D-3-1. Resistance to Compressing

D-3-2. StirMark

D-3-3. Expansion and Contraction

D-4. Effects of First and Second Embodiments

E. Third Embodiment

E-1. Digital Watermark Embedding Process

E-2. Modification of Digital Watermark Embedding Process

E-3. Digital Watermark Extraction Process

F. Concrete Examples and Summary of Third Embodiment

F-1. Quantity of Embeddable Information

F-2. Effects of Third Embodiment

G. Fourth Embodiment

G-1. Digital Watermark Embedding Process

G-2. Digital Watermark Extraction Process

G-3. Modification of Digital Watermark Embedding Process

H. Concrete Examples and Summary of Fourth Embodiment

H-1. Embedding into Multiple Colors

H-2. Quantity of Embeddable Information

H-3. Resistance to Attacks

H-3-1. Resistance to Compressing

H-3-2. StirMark

I. Fifth Embodiment

I-1. Digital Watermark Embedding Process

I-2. Modification of Digital Watermark Embedding Process

I-3. Digital Watermark Extraction Process

J. Modifications

J-1. First Modification

J-2. Second Modification

J-3. Third Modification

J-4. Fourth Modification

J-5. Fifth Modification

J-6. Sixth Modification

J-7. Seventh Modification

A. Construction of Apparatus

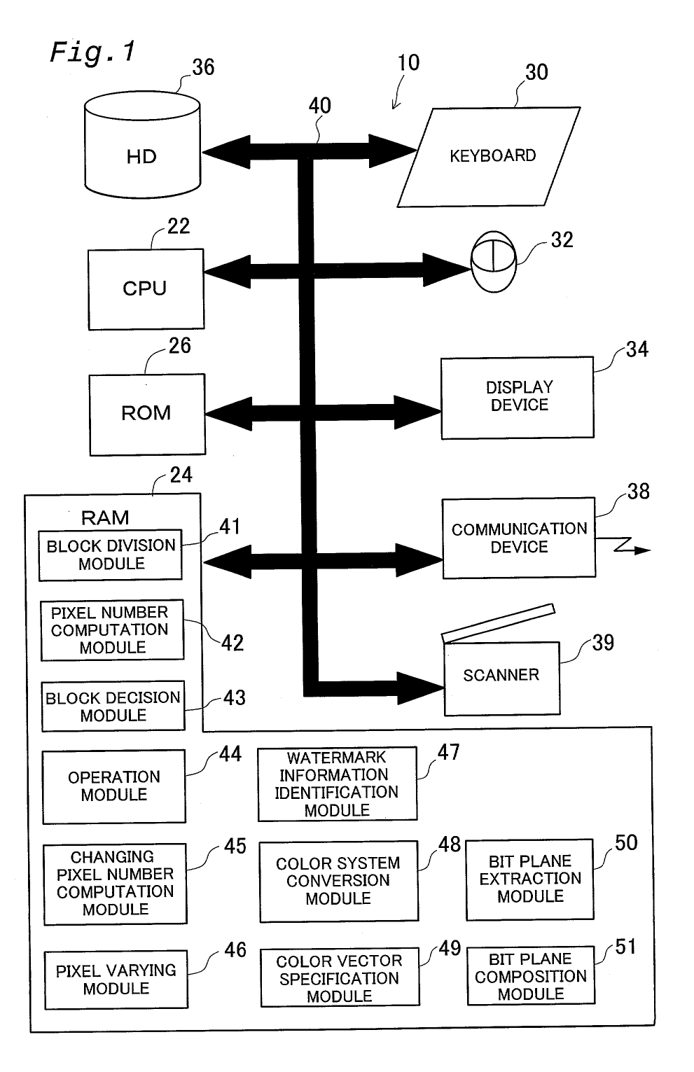

The description first regards the construction of a digital watermarking apparatus 10 commonly used in first through fifth embodiments of the present invention, with reference to FIG. 1. FIG. 1 is a block diagram illustrating the construction of the digital watermarking apparatus 10 that carries out a digital watermark embedding process and a digital watermark extraction process of the present invention. The digital watermarking apparatus 10 is a computer including a CPU 22, a RAM 24, a ROM 26, a keyboard 30, a mouse 32, a display unit 34 like a CRT, a hard disk unit 36, a communication device 38 like a network card or a modem, a scanner 39 that reads images, and a bus 40 that connects these elements with one another. Diverse interface circuits are omitted from the illustration of FIG. 1. The communication device 38 is connected to a computer network via a non-illustrated communication line. A non-illustrated server of the computer network functions as a program supply device that supplies computer programs to the digital watermarking apparatus 10 via the communication line.

The RAM 24 stores a computer program for actualizing the functions of diverse modules, which include a block division module 41 that divides image data of interest into multiple blocks, a pixel number computation module 42 that computes the number of pixels fulfilling a predetermined condition among all the pixels included in each of the multiple blocks, a block decision module 43 that determines whether or not each block allows embedding of watermark information based on the computed number of pixels, and an operation module 44 that makes the computed number of pixels subjected to a predetermined operation with regard to the block determined to allow embedding. The diverse modules also include a changing pixel number computation module 45 that computes the number of specified pixels to be changed according to the result of the operation, a pixel varying module 46 that varies the pixel value with regard to the computed number of specified pixels among the pixels included in each block, and a watermark information identification module 47 that identifies embedded watermark information based on the result of the operation in the process of extracting the watermark information from each block. The diverse modules further include a color system conversion module 48 that converts the color system when the image data of interest is color image data, a bit plane extraction module 49 that extracts bit planes from the image data when the image data of interest is multi-valued image data, and a bit plane composition module 50 that combines the bit planes to restore original multi-valued image data. The detailed functions of the respective modules will be discussed later.

The computer program for actualizing the functions of the respective modules 41 through 50 is recorded in a computer readable recording medium, such as a flexible disk or a CD-ROM. The computer reads out the computer program recorded in the recording medium and transfers the computer program to either its internal storage device or external storage device. The computer program may be supplied to the computer via a communication path. A microprocessor of the computer executes the computer program stored in the internal storage device to actualize the functions of the computer program. The computer may directly read and execute the computer program recorded in the recording medium.

In the specification hereof, the computer is a concept including a hardware and an operating system, and represents the hardware working under control of the operating system. In the case where the operating system is unnecessary and the hardware is driven and actuated by an application program alone or by a firmware alone, the hardware itself corresponds to the computer. The hardware includes at least a microprocessor, such as a CPU, and means for reading the computer program recorded in the recording medium. The concept of the computer includes electronic devices, such as digital cameras and scanners, which have built-in CPU and ROM and exert the functions of the computer. The computer program includes program codes that cause the computer to actualize the functions of the respective means discussed above. Part of the functions may be actualized by the operating system, instead of the application program. The program for digital watermark embedding process and the digital watermark extraction process may be added in the form of a plug-in to a program of image processing.

The ‘recording medium’ of the present invention may be any of flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

B. First Embodiment

B-1. Digital Watermark Embedding Process

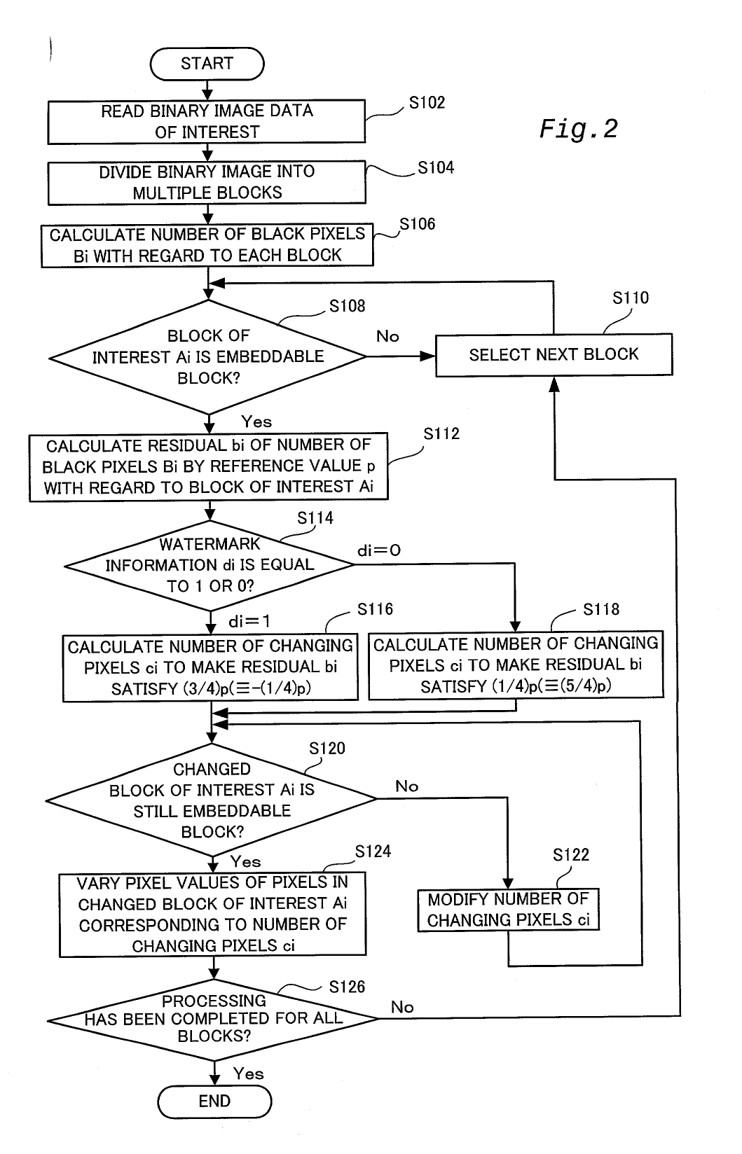

FIG. 2 is a flowchart showing a routine of the digital watermark embedding process executed in a first embodiment of the present invention. This routine is executed by the block division module 41, the pixel number computation module 42, the block decision module 43, the operation module 44, the changing pixel number computation module 45, and the pixel varying module 46 shown in FIG. 1.

In this embodiment, binary image data representing a cartoon is stored in advance as image data of interest in the hard disk unit 36. The binary image data of interest may be obtained by reading a cartoon drawn on a sheet of paper with the scanner 39 or by extracting display data of a cartoon drawn on the screen of the display unit 34 according to an imaging software program.

When the program enters the digital watermarking embedding routine shown in the flowchart of FIG. 2, the block division module 41 first reads the binary image data of interest from the hard disk unit 36 (step S102) and divides a binary image expressed by the binary image data of interest into multiple blocks (step S104).

The binary image has a size of M×N pixels, and the pixel value of coordinates (x,y) in the binary image is expressed as a(x,y). In this embodiment, the pixel value ‘a’ of background color (white) in the binary image (cartoon) is equal to ‘0’, and the pixel value ‘a’ of each line-work object like a line segment or a character (black) is equal to ‘1’.

The block division module 41 divides the read-out binary image into rectangular blocks of m×n pixels.

The pixel number computation module 42 calculates a number of black pixels Bᵢ (pixel value a=1) with regard to each divisional block Aᵢ (i=1, 2, 3, . . . ) (step S106).

The number of black pixels Bᵢ in the block Aᵢ is calculated according to Equation (1) given below, where the base point of the block Aᵢ is expressed by coordinates (xᵢ,yᵢ):

$${B}_{i} = {\sum }_{l = 0}^{n - 1} {\sum }_{k = 0}^{m - 1} a ( {x}_{i} + k , {y}_{i} + l ) \qquad ( 1 )$$

The block decision module 43 selects one block of interest among the plurality of divisional blocks. The block decision module 43 then determines whether or not the selected block of interest Ai is an embeddable block of watermark information, based on the calculated number of black pixels Bi with regard to the block of interest (step S108).

The embeddable block represents a block having the number of black pixels Bi that satisfy Conditional Expression (2) given below:

p≦Bᵢ≦m×n−p (2)

where p is a fixed reference value. Namely the embeddable block simultaneously includes at least ‘p’ black pixels and at least ‘p’ white pixels.

The determination of whether or not the block of interest is an embeddable block effectively prevents deterioration of the picture quality due to embedding of watermark information. For example, when the block that does not satisfy Conditional Expression (2) given above is a block completely filled with black pixels, introduction of white pixels into this block to embed watermark information as described later makes the white pixels undesirably conspicuous and deteriorates the picture quality. In the case of a practically blank block, on the other hand, dispersion of black pixels in the block to embed watermark information makes the black pixels undesirably conspicuous and deteriorates the picture quality.

The determination is accordingly carried out to omit blocks that may cause deterioration of the picture quality due to embedding of watermark information.

When the result of determination shows that the block of interest Aᵢ is not an embeddable block, the block decision module 43 selects a subsequent block Aᵢ₊₁ as a next block of interest (step S110) and carries out the above determination with regard to the newly selected block.

When the result of determination shows that the block of interest Aᵢ is an embeddable block, on the other hand, the processing of and after step S112 is carried out to embed watermark information into the block of interest Aᵢ.

In this embodiment, watermark information dᵢ is a series of binary digits obtained by expanding a series of characters or a series of digits representing copyright information to binary digits, and is either dᵢ=0 or dᵢ=1 (i=1,2,3, . . . , E). Here E represents the number of embeddable blocks present in the binary image.

The following describes the procedure of the embodiment for embedding the watermark information dᵢ into the block of interest Aᵢ, which is an embeddable block.

When the watermark information dᵢ to be embedded into the block of interest Aᵢ is equal to ‘1’, the procedure in principle varies the pixel values of specified pixels, which are part of the block of interest Aᵢ, to make a residual bᵢ of the number of black pixels Bᵢ by the reference value p equal to (3/4)p. When the watermark information dᵢ to be embedded is equal to ‘0’, on the other hand, the procedure in principle varies the pixel values of specific pixels to make the residual bᵢ equal to (1/4)p.

The residual bᵢ by the reference value p is essentially in a range of 0≦bᵢ<p. The pixel values of the specific pixels are varied, such that the residuals bᵢ are parted into 1/4 and 3/4 of this range according to the watermark information dᵢ.

This procedure transforms the watermark information into planar expansion (distribution) information of black pixels for embedding.

According to the above embedding principle, the operation module 44 calculates the residual bᵢ of the number of black pixels Bᵢ by the reference value p with regard to the block of interest Aᵢ (step S112). The concrete procedure carries out an operation expressed by Equation (3) given below:

bᵢ=Bᵢ mod p (3)

The changing pixel number computation module 45 subsequently determines whether the watermark information dᵢ to be embedded into the block of interest Aᵢ is equal to ‘1’ or ‘0’ (step S114). When the result of determination shows that the watermark information dᵢ is equal to ‘1’, the changing pixel number computation module 45 calculates a number of pixels for which the pixel values are to be changed (hereafter referred to as the number of changing pixels) cᵢ to make the residual bᵢ equal to (3/4)p (step S116). When the watermark information dᵢ is equal to ‘0’, on the other hand, the number of changing pixels cᵢ is calculated to make the residual bᵢ equal to (1/4)p (step S118).

In this embodiment, the number of changing pixels cᵢ takes a positive value when the pixel value a(x,y) is varied from ‘0’ to ‘1’, while taking a negative value when the pixel value a(x,y) is varied from ‘1’ to ‘0’.

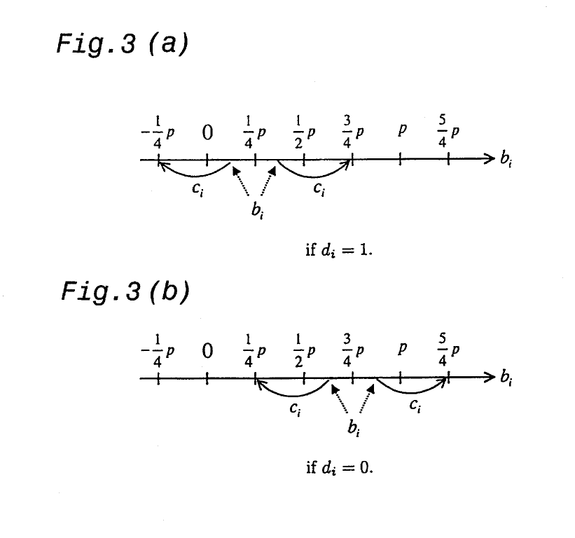

As clearly understood from FIG. 3(a), if the number of changing pixels cᵢ is calculated to consistently make the residual bᵢ equal to (3/4)p under the condition of the watermark information dᵢ equal to ‘1’, the absolute value |cᵢ| of the number of changing pixels becomes greater than (1/2)p when the residual bᵢ is less than (1/4)p. The absolute value |cᵢ| of the number of changing pixels represents the number of pixels in the original image for which the pixels values are to be changed. The increase in absolute value thus leads to deterioration of the picture quality. When the absolute value |cᵢ| of the number of changing pixels is greater than (1/2)p, actual variation of the pixel values with regard to the pixels of the absolute value |cᵢ| significantly damages the picture quality.

The procedure of the embodiment utilizes a relationship of Equation (4) given below and calculates the number of changing pixels cᵢ to make the residual bᵢ equal to −(1/4)p when the watermark information dᵢ=1 and the residual bᵢ is less than (1/4)p. Such computation enables the absolute value |cᵢ| of the number of changing pixels to satisfy a relation of |cᵢ|≦(1/2)p.

$$- \frac{1}{4} p ≡ \frac{3}{4} p ( mod p ) \qquad ( 4 )$$

A similar phenomenon is observed when the watermark information dᵢ is equal to ‘0’. As clearly understood from FIG. 3(b), if the number of changing pixels cᵢ is calculated to consistently make the residual bᵢ equal to (1/4)p under the condition of the watermark information dᵢ equal to ‘0’, the absolute value |cᵢ| of the number of changing pixels becomes greater than (1/2)p when the residual bᵢ is greater than (3/4)p. The actual variation of the pixel values with regard to the pixels of the absolute value |cᵢ| significantly damages the picture quality.

The procedure of the embodiment utilizes a relationship of Equation (5) given below and calculates the number of changing pixels cᵢ to make the residual bᵢ equal to (5/4)p when the watermark information dᵢ=0 and the residual bᵢ is greater than (3/4)p.

$$\frac{5}{4} p ≡ \frac{1}{4} p ( mod p ) \qquad ( 5 )$$

In summary, the changing pixel number computation module 45 calculates the number of changing pixels cᵢ according to Equations (6) depending upon the value of the residual bᵢ, when the watermark information dᵢ is equal to ‘1’:

$${c}_{i} = \{ \begin{matrix}- \frac{1}{4} p - {b}_{i} & if {b}_{i} < \frac{1}{4} p \\ \frac{3}{4} p - {b}_{i} & if {b}_{i} \geq \frac{1}{4} p\end{matrix} \qquad ( 6 )$$

When the watermark information dᵢ is equal to ‘0’, on the other hand, the changing pixel number computation module 45 calculates the number of changing pixels cᵢ according to Equations (7) depending upon the value of the residual bᵢ:

$${c}_{i} = \{ \begin{matrix}\frac{5}{4} p - {b}_{i} & if {b}_{i} > \frac{3}{4} p \\ \frac{1}{4} p - {b}_{i} & if {b}_{i} \leq \frac{3}{4} p\end{matrix} \qquad ( 7 )$$

The block decision module 43 determines whether or not the changed block of interest Aᵢ is still an embeddable block, in the case where the pixel values are varied with regard to pixels in the block of interest Aᵢ corresponding to the number of changing pixels cᵢ calculated according to Equations (6) or (7) (step S120). When the pixel values of the pixels in the block of interest Aᵢ are varied, the number of black pixels present in the block of interest Aᵢ is equal to (Bᵢ+cᵢ). The procedure thus determines whether or not this number of black pixels (Bᵢ+cᵢ) satisfies Conditional Expression (2) given above. Here the number of black pixels Bᵢ in Conditional Expression (2) should be changed to (Bᵢ+cᵢ).

When the result of determination shows that the changed block of interest Aᵢ is no longer an embeddable block, the changing pixel number computation module 45 modifies the calculated number of changing pixels cᵢ according to Equations (8) given below (step S122):

$${c}_{i} ← \{ \begin{matrix}{c}_{i} - p & if {B}_{i} + {c}_{i} > m \times n - p \\ {c}_{i} + p & if {B}_{i} + {c}_{i} < p\end{matrix} \qquad ( 8 )$$

When the result of determination shows that the changed block of interest Aᵢ is still an embeddable block, on the other hand, the pixel varying module 46 varies the pixel values of the pixels in the block of interest Aᵢ corresponding to the final number of changing pixels cᵢ (step S124).

In accordance with a concrete procedure, the pixel varying module 46 inverts pixels on an edge of a drawing object, such as a line or a character, in the block of interest Aᵢ corresponding to the absolute value |cᵢ| of the number of changing pixels, from white to black in the case of the positive number of changing pixels cᵢ and from black to white in the case of the negative number of changing pixels cᵢ. Namely the pixel values a(x,y) of the pixels on the edge are varied from ‘0’ to ‘1’ in the case of the positive number of changing pixels cᵢ, while being varied from ‘1’ to ‘0’ in the case of the negative number of changing pixels cᵢ.

A number of black pixels Bᵢ′ in the changed block of interest Aᵢ is equal to (Bᵢ+cᵢ) as mentioned previously. A residual bᵢ′ of the changed number of black pixels Bᵢ′ by the reference value p is accordingly expressed by Equations (9) given below:

$${b}_{i}^{′} = {B}_{i}^{′} mod p = \{ \begin{matrix}\frac{3}{4} p & if {d}_{i} = 1 \\ \frac{1}{4} p & if {d}_{i} = 0\end{matrix} \qquad ( 9 )$$

The residual bᵢ′ of the changed number of black pixels Bᵢ′ by the reference value p is thus equal to either (3/4) p or (1/4)p according to the value of the watermark information dᵢ embedded.

The block decision module 43 determines whether or not the above series of processing has been completed for all the divisional blocks of the binary image (step S126). When the processing has not yet been completed, the block decision module 43 selects a subsequent block Aᵢ₊₁ as a next block of interest (step S110) and executes the series of processing of and after step S108. When the processing has been completed for all the blocks, on the other hand, the program exits from the digital watermark embedding routine shown in FIG. 2.

The digital watermark embedding process described above enables the watermark information representing copyright information to be embedded in binary image data representing a cartoon. The parameters used in this embedding process, that is, the dimensions of each block (m pixels by n pixels) and the reference value p, are secret keys required for extraction of the embedded watermark information.

B-2. Digital Watermark Extraction Process

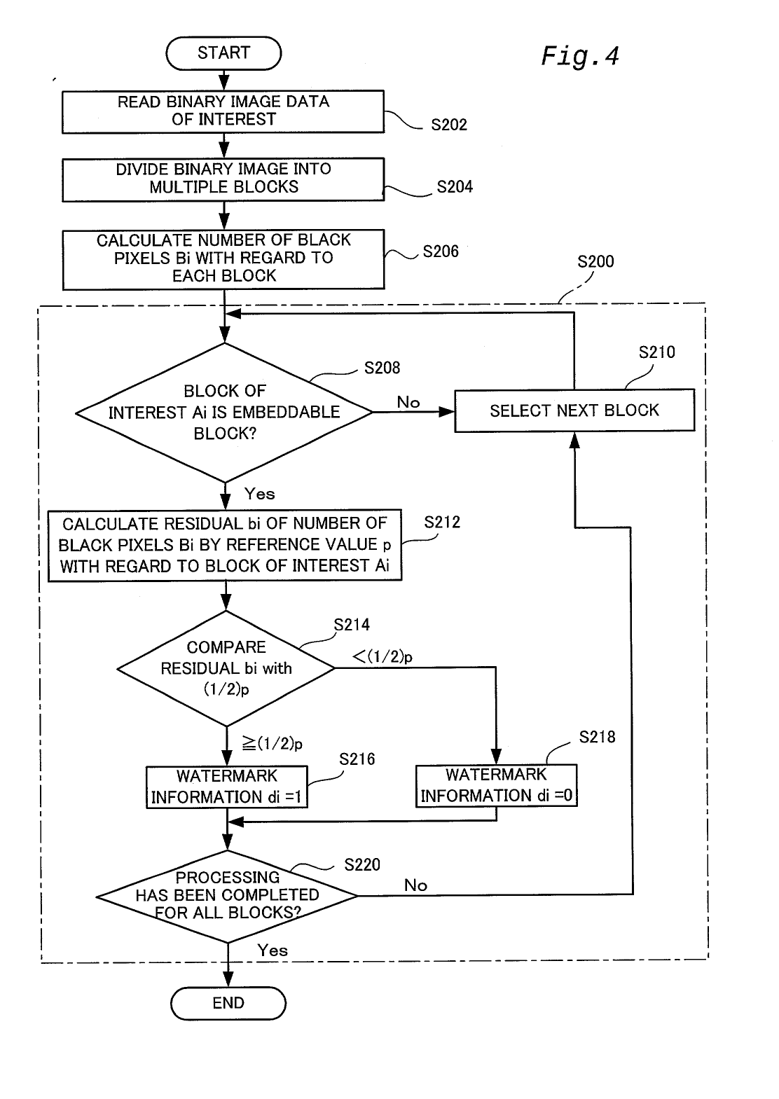

FIG. 4 is a flowchart showing a routine of the digital watermark extraction process executed in the first embodiment of the present invention. This routine is executed by the block division module 41, the pixel number computation module 42, the block decision module 43, the operation module 44, and the information identification module 47 shown in FIG. 1.

In this embodiment, binary image data with watermark information embedded therein by the digital watermark embedding process shown in FIG. 2 is stored in advance as image data of interest in the hard disk unit 36.

When the program enters the digital watermark extraction routine shown in FIG. 4, the block division module 41 first reads out binary image data of interest with watermark information embedded therein from the hard disk unit 36 (step S202). The block division module 41 specifies the size of each block (m pixels by n pixels) according to separate information of secret keys used in the process of embedding the watermark information into the binary image data, and divides the read-out binary image into multiple rectangular blocks having the size of m×n pixels (step S204).

The pixel number computation module 42 then calculates the number of black pixels Bᵢ′ included in each divisional block Aᵢ according to Equation (1) given above (step S206).

The block decision module 43 selects one block of interest among the multiple divisional blocks. The block decision module 43 obtains the reference value p from the information of the secret keys and determines whether or not the selected block of interest Aᵢ is an embeddable block of watermark information according to Conditional Expression (2) given above, based on the number of black pixels Bᵢ′ calculated at step S204 and the obtained reference value p (step S208).

When the result of determination shows that the block of interest Aᵢ is an embeddable block, it is assumed that the watermark information dᵢ is embedded in the block of interest Aᵢ. The processing of and after step S212 is accordingly executed to extract the watermark information from the block of interest Aᵢ. When the result of determination shows that the block of interest Aᵢ is not an embeddable block, on the other hand, no watermark information is embedded in the block of interest Aᵢ. The block decision module 43 accordingly selects a subsequent block Aᵢ₊₁ as a next block of interest (step S210) and carries out the above determination with regard to the newly selected block.

In the process of extracting the watermark information from the block of interest Aᵢ, the operation module 44 first calculates the residual bᵢ′ of the number of black pixels Bᵢ′ by the reference value p with regard to the block of interest Aᵢ according to Equation (3) given above (step S212).

The information identification module 47 subsequently compares the calculated residual bᵢ′ with a threshold value (1/2)p obtained from the reference value p (step S214). The residual bᵢ by the reference value p is essentially in a range of 0≦bᵢ<p. The threshold value is accordingly set at 1/2 of this range, and the residuals bᵢ′ are grouped into a divisional range of 0≦bᵢ′<(1/2)p and another range of (1/2)p≦bᵢ′<p.

As described previously, it is expected that the residual bᵢ′ of the number of black pixels Bᵢ′ by the reference value p is equal to either (3/4) p or (1/4)p according to the value of the embedded watermark information dᵢ as shown by Equations (9) given above. Grouping of the calculated residuals bᵢ′ in the above manner enables the embedded watermark information dᵢ to be readily identified. In the actual state, due to the effects of noise, for example, the residual bᵢ′ may not be just equal to (3/4)p or (1/4)p. In order to eliminate the effects of noise, the margins are set for the comparison as bᵢ′<(1/2)p and (1/2)p≦bᵢ′.

When the result of comparison shows that the residual bᵢ′ is in the range of bᵢ′≧(1/2)p, the information identification module 47 identifies the embedded watermark information dᵢ equal to ‘1’ according to Equations (10) given below (step S216). In the range of bᵢ′<(1/2)p, on the other hand, the information identification module 47 identifies the embedded watermark information dᵢ equal to ‘0’ (step S218).

$${d}_{i} = \{ \begin{matrix}1 & if {b}_{i} \geq \frac{1}{2} p \\ 0 & if {b}_{i} < \frac{1}{2} p\end{matrix} \qquad ( 10 )$$

This procedure extracts the watermark information dᵢ embedded in the block of interest Aᵢ.

The block decision module 43 determines whether or not the above series of processing has been completed for all the divisional blocks of the binary image (step S220). When the processing has not yet been completed, the block decision module 43 selects a subsequent block Aᵢ₊₁ as a next block of interest (step S210) and executes the series of processing of and after step S208. When the processing has been completed for all the blocks, on the other hand, the program exits from the digital watermark extraction routine shown in FIG. 4.

The processing of steps S208 through S220 in the flowchart of FIG. 4 is hereafter referred to as the watermark information identification process (step S200).

The digital watermark extraction process described above extracts the watermark information embedded in the binary image data representing a cartoon and takes out the copyright information of the cartoon. This procedure of the embodiment does not require an original image but enables extraction of the embedded watermark information with the secret keys.

The number of blocks E′ determined as embeddable blocks at the time of extracting watermark information may not be coincident with the number of blocks E determined as embeddable blocks at the time of embedding watermark information, due to noise and malicious attacks by any third person.

C. Second Embodiment

The procedure of the first embodiment varies the pixel values of the specified pixels, which are part of the block of interest Aᵢ, in principle to make the residual bᵢ of the number of black pixels Bᵢ by the reference value p equal to (3/4)p in the case of the watermark information dᵢ equal to ‘1’, and to make the residual bᵢ equal to (1/4)p in the case of the watermark information dᵢ equal to ‘0’.

Such variation of the pixel values to make the residual bᵢ equal to either (3/4)p or (1/4)p, however, causes an extremely localized distribution of pixels in the changed pixel of interest Aᵢ. This may allow a third person to detect the artificial processing.

In order to eliminate such drawbacks, the procedure of a second embodiment varies the pixels values of specific pixels, which are part of the block of interest Aᵢ, in order to attain a random distribution of the residual bᵢ of the number of black pixels Bᵢ by the reference value p in a section ((1/2)p,p) in the case of the watermark information dᵢ equal to ‘1’ and attain a random distribution of the residual bᵢ in a section (0,(1/2)p) in the case of the watermark information dᵢ equal to ‘0’.

C-1. Digital Watermark Embedding Process

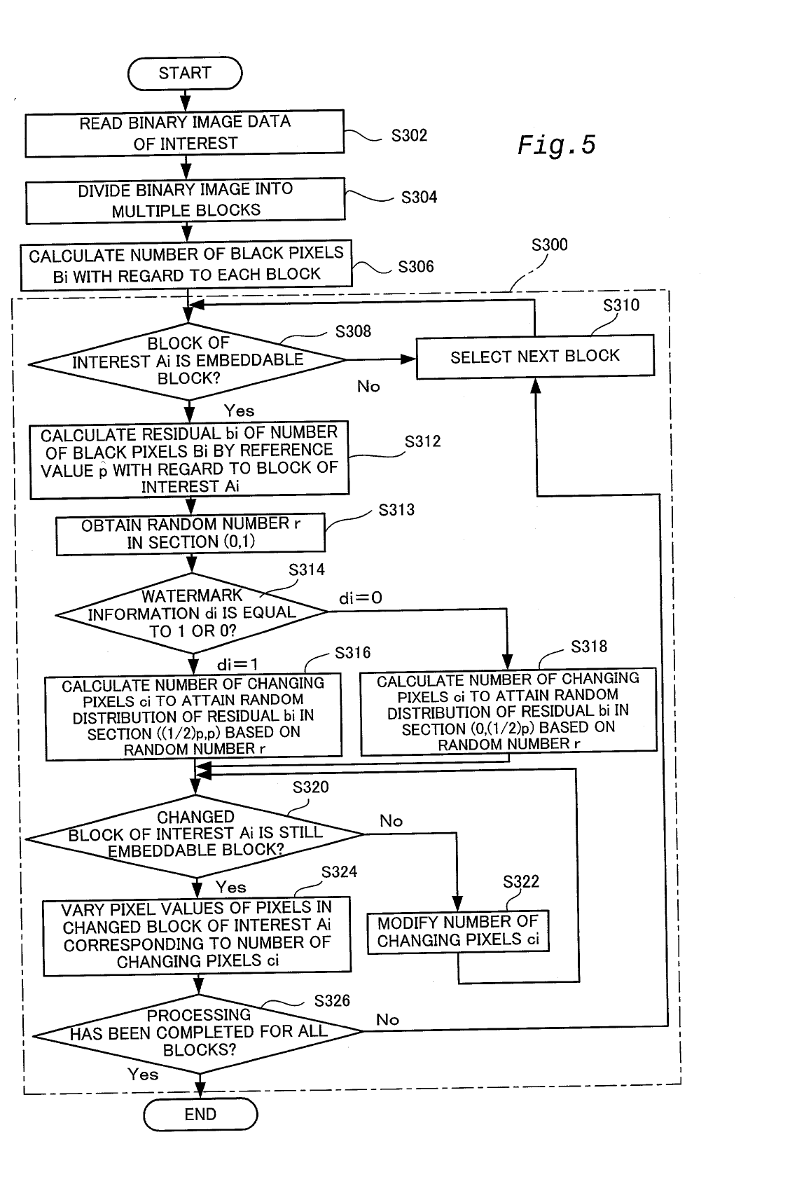

FIG. 5 is a flowchart showing a routine of the digital watermark embedding process executed in the second embodiment of the present invention. This routine is executed by the block division module 41, the pixel number computation module 42, the block decision module 43, the operation module 44, the changing pixel number computation module 45, and the pixel varying module 46 shown in FIG. 1.

The premise of the digital watermark embedding process in this embodiment is identical with that of the first embodiment. The processing of steps S302 through S312 in the flowchart of FIG. 5 is identical with the processing of steps S102 through S112 of the first embodiment shown in the flowchart of FIG. 1 and is thus not specifically described here.

In the flowchart of FIG. 5, when it is determined at step S308 that the block of interest Aᵢ is an embeddable block, the changing pixel number computation module 45 utilizes a rand( ) function of ANSI C Standard X3. 159-1989 (America National Standard for Information Systems—Programming Language C) to obtain a random number r that may be present in a section (0,1) (step S313). The concrete procedure obtains the random number r according to Equation (11) given below:

$$r = \frac{rand ( )}{RAND\_MAX + 1} \qquad ( 11 )$$

The changing pixel number computation module 45 then determines whether the watermark information dᵢ to be embedded in the block of interest Aᵢ is equal to ‘1’ or ‘0’ (step S314). When the result of determination shows that the watermark information dᵢ is equal to ‘1’, the number of changing pixels cᵢ is calculated to attain a random distribution of the residual bᵢ of the number of black pixels Bᵢ by the reference value p in a section ((1/2)p,p), based on the obtained random number r (step S316). In the case of the watermark information dᵢ equal to ‘0’, on the other hand, the number of changing pixels cᵢ is calculated to attain a random distribution of the residual bᵢ in a section (0,(1/2)p) (step S318).

In accordance with a concrete procedure, in the case of the watermark information dᵢ equal to ‘1’, the changing pixel number computation module 45 calculates the number of changing pixels cᵢ according to Equation (12) given below with the residual bᵢ and the random number r:

$${c}_{i} = \frac{1}{2} p \times r + \frac{1}{2} p - {b}_{i} \qquad ( 12 )$$

In the case of the watermark information dᵢ equal to ‘0’, on the other hand, the changing pixel number computation module 45 calculates the number of changing pixels cᵢ according to Equation (13) given below with the residual bᵢ and the random number r:

$${c}_{i} = \frac{1}{2} p \times r - {b}_{i} \qquad ( 13 )$$

The subsequent processing of steps S320 through S326 in the flowchart of FIG. 5 is identical with the processing of steps S120 through S126 of the first embodiment in the flowchart of FIG. 1 and is thus not specifically described here.

The processing of steps S308 through S326 in the flowchart of FIG. 5 is hereafter referred to as the value variation process (step S300).

As described above, the digital watermark embedding process of this embodiment varies the pixel values of the specified pixels, which are part of the block of interest Aᵢ, to attain random distributions of the residual bᵢ of the number of black pixels Bᵢ by the reference value p in the sections ((1/2)p,p) and (0,(1/2)p) according to the value of the watermark information dᵢ to be embedded in the process of embedding the watermark information into the block of interest Aᵢ. This arrangement enables watermark information to be embedded without causing any localized distribution of pixels in the changed pixel of interest Aᵢ. No third person can thus detect the artificial processing. Even total retrieval by any malicious third person can not practically specify the secret keys m, n, and p.

C-2. First Modification of Digital Watermark Embedding Process

Like the first embodiment, in the procedure of this embodiment, the absolute value |cᵢ| of the number of changing pixels cᵢ, which is calculated according to either Equation (12) or Equation (13) at step S316 or S318, may be greater than (1/2)p according to the residual bᵢ and the random number r. As described previously, the increase in absolute value |cᵢ| of the number of changing pixels to exceed (1/2)p significantly deteriorates the picture quality when the pixel values are varied in the pixels corresponding to the absolute value |cᵢ|.

When the absolute value |cᵢ| of the number of changing pixels cᵢ calculated according to either Equation (12) or Equation (13) exceeds (1/2)p (|cᵢ|>(1/2)p); the changing pixel number computation module 45 again generates a random number r and recalculates the number of changing pixels cᵢ according to Equation (12) or Equation (13) based on the new random number r. This procedure is repeated until the absolute value |cᵢ| of the number of changing pixels does not exceed (1/2)p (|cᵢ|≦(1/2)p).

This arrangement desirably prevents deterioration of the picture quality due to the varied pixel values.

C-3. Second Modification of Digital Watermark Embedding Process

In the procedure of the above embodiment, the block decision module 43 determines whether or not the changed block of interest Aᵢ is still an embeddable block (that is, satisfies Conditional Expression (2)) at step S320. When the result of determination shows that the changed block of interest Aᵢ is no longer an embeddable block, the changing pixel number computation module 45 modifies the number of changing pixels cᵢ according to Equations (8) (step S322).

Instead of the modification of the number of changing pixels cᵢ according to Equations (8), one possible modification causes the changing pixel number computation module 45 to generate a random number r again and recalculate the number of changing pixels cᵢ based on the new random number r. This procedure is repeated until it is determined that the changed block of interest Aᵢ is still an embeddable block (that is, satisfies Conditional Expression (2)).

While the number of black pixels Bᵢ in the block of interest Aᵢ is a maximum value (m×n−p) of Conditional Expression (2) and the watermark information dᵢ is equal to ‘1’, in the case where the residual bᵢ of the number of black pixels Bᵢ by the reference value p is not in the section ((1/2)p,p), recalculation with a newly generated random number r can not give the adequate number of changing pixels cᵢ. In such cases, the number of changing pixels cᵢ is corrected according to an equation of cᵢ←cᵢ−p.

C-4. Third Modification of Digital Watermark Embedding Process

In the procedure of the above embodiment, the changing pixel number computation module 45 calculates the number of changing pixels cᵢ according to Equation (12) in the case of the watermark information dᵢ equal to ‘1’ and according to Equation (13) in the case of the watermark information dᵢ equal to ‘0’, regardless of the residual bᵢ of the number of black pixels Bᵢ by the reference value p. In the case of the watermark information dᵢ equal to ‘1’, when the residual bᵢ calculated at step S312 satisfies the relation of (1/2)p≦bᵢ<p, the residual bᵢ has already been distributed at random in the section ((1/2)p,p). In the case of the watermark information dᵢ equal to ‘0’, when the residual bᵢ calculated at step S312 satisfies the relation of 0≦bᵢ<(1/2)p, the residual bᵢ has already been distributed at random in the section (0,(1/2)p). In such cases, there is no need of varying the pixel values of the pixels in the block of interest Aᵢ.

One modified example inserts a decision step between steps S312 and S313 in the flowchart of FIG. 5 to determine whether either one of Condition 1 and Condition 2 is fulfilled. Condition 1 is that the watermark information dᵢ is equal to ‘1’ and the residual bᵢ calculated at step S312 satisfies the relation of (1/2)p≦bᵢ<p. Condition 2 is that the watermark information dᵢ is equal to ‘0’ and the residual bᵢ calculated at step S312 satisfies the relation of 0≦bᵢ<(1/2)p. When either of Conditions 1 and 2 is fulfilled, the program skips steps S313 through S320 and proceeds directly to step S324, on the assumption that the number of changing pixels cᵢ is equal to ‘0’. The program may alternatively skip steps S313 through S324 and proceed directly to step S326. The watermark information is then embedded in the block of interest Aᵢ without practically varying the pixel values of the pixels in the block.

The procedure of this modified example varies the pixel values of the pixels only in the required minimum block, in the process of embedding the watermark information. This desirably reduces deterioration of the picture quality due to embedding of watermark information and shortens the total processing time.

C-5. Fourth Modification of Digital Watermark Embedding Process

In the procedure of the above embodiment, the changing pixel number computation module 45 calculates the number of changing pixels cᵢ according to Equation (12) in the case of the watermark information dᵢ equal to ‘1’ and according to Equation (13) in the case of the watermark information dᵢ equal to ‘0’. The calculated number of changing pixels cᵢ may take a negative value according to the residual bᵢ and the random number r. In the case of the negative number of changing pixels cᵢ, part of the pixels in the block of interest Aᵢ are eventually changed from black to white at step S324.

In some images, the variation from black to white is undesirable, while the variation from white to black is allowable. The pixel values should then be all varied from white to black.

The procedure of one possible modification calculates the number of changing pixels cᵢ according to either Equation (12) or Equation (13) and, if the calculated value cᵢ is negative (cᵢ<0), corrects the number of changing pixels cᵢ by utilizing a relation of Equation (14) given below:

cᵢ≡cᵢ+p(mod p) (14)

When the calculated number of changing pixels cᵢ is negative, the procedure adds the reference value p to the number of changing pixels cᵢ to determine the new number of changing pixels cᵢ.

cᵢ←cᵢ+p(cᵢ<0) (15)

Such correction to the number of changing pixels cᵢ keeps the number of changing pixels cᵢ not less than 0. The pixel values are accordingly all varied from white to black at step S324.

In other images, the variation from white to black is undesirable, while the variation from black to white is allowable. In such cases, on the contrary, when the calculated number of changing pixels cᵢ is positive, the procedure subtracts the reference value p from the number of changing pixels cᵢ to determine the new number of changing pixels cᵢ. This keeps the number of changing pixels cᵢ not greater than 0. The pixel values are accordingly all varied from black to white at step S324.

C-6. Digital Watermark Extraction Process

The process of extracting watermark information from binary image data with the watermark information embedded therein in this embodiment follows the digital watermark extraction process of the first embodiment described above with reference to FIG. 4, and is thus not specifically described here.

In the watermark information embedding process shown in FIG. 5, the residual bᵢ′ of the number of black pixels Bᵢ′ by the reference value p calculated according to Equation (12) or Equation (13) is either in the section ((1/2)p,p) or in the section (0,(1/2)p), depending upon the value of the embedded watermark information dᵢ. The processing of step S214 in the flowchart of FIG. 4 parts the residual bᵢ′ calculated at step S212 into the range of 0≦bᵢ′<(1/2)p and the range of (1/2)p≦bᵢ′<p. This arrangement enables the embedded watermark information dᵢ to be readily identified. The information identification module 47 specifies that the embedded watermark information dᵢ is equal to ‘1’ as expressed by Equation (10) given above (step S216), when the result of comparison at step S214 shows that the calculated residual bᵢ′ satisfies the relation of bᵢ′≧(1/2)p. When bᵢ′<(1/2)p, the information identification module 47 specifies that the embedded watermark information dᵢ is equal to ‘0’ (step S218).

The digital watermark extraction process of this embodiment accordingly extracts the watermark information embedded in the binary image data representing a cartoon and takes out the copyright information of the cartoon.

D. Concrete Examples and Summary of First and Second Embodiments

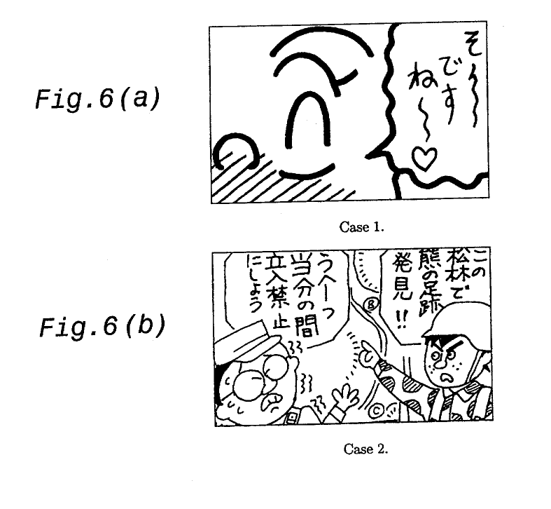

The following describes concrete examples of embedding watermark information into binary images, which are respectively one frame of four-frame cartoons shown in FIG. 6. FIG. 6(a) shows an image of Case 1, and FIG. 6(b) shows an image of Case 2. Each image has a size of 800×500 pixels.

D-1. Quantity of Embeddable Information

As described previously, the total number of blocks E₀ is expressed by Equation (16) given below, where the size of the binary image is M×N pixels and the size of each divisional block A is m×n pixels:

$${E}_{0} = ⌊ \frac{M}{m} ⌋ \times ⌊ \frac{N}{n} ⌋ \qquad ( 16 )$$

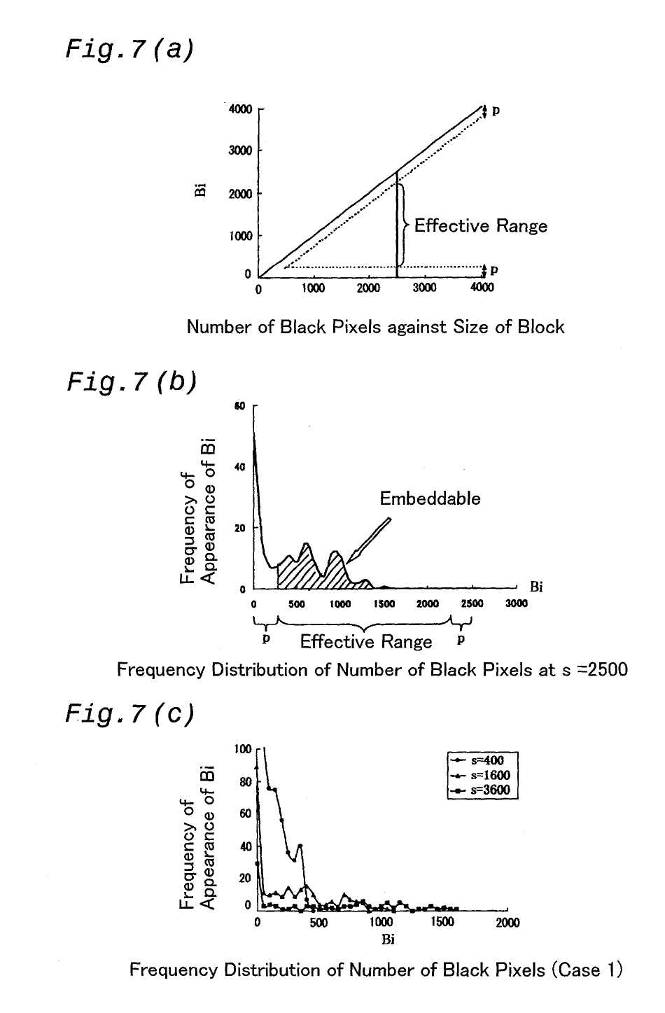

The available number of black pixels Bᵢ is plotted against the size s of the block Aᵢ in FIG. 7(a). For example, when Conditional Expression (2) is applied for the reference value p=256, the number of black pixels Bᵢ, which may be in an embeddable block, is limited to an area defined by the dotted lines in FIG. 7(a).

FIG. 7(b) shows the relationship between the number of black pixels Bᵢ and the frequency of its appearance in the block Aᵢ having the size s equal to 2500. A hatched area in FIG. 7(b) corresponds to the number of embeddable blocks (that is, the quantity of embeddable information) E at the reference value p. Left and right areas of a width p on both sides of the hatched area correspond to blocks set to prohibit embedding of watermark information and thereby prevent deterioration of the picture quality.

FIG. 7(c) shows the relationship between the number of black pixels Bᵢ and the frequency of its appearance in the blocks Aᵢ having the size s equal to 400, 1600, and 3600 with regard to the image of Case 1 shown in FIG. 6(a). As clearly seen from FIG. 7(c), a reduction in size s of the block Aᵢ at a fixed reference value p increases the number of blocks that do not fulfil Conditional Expression (2).

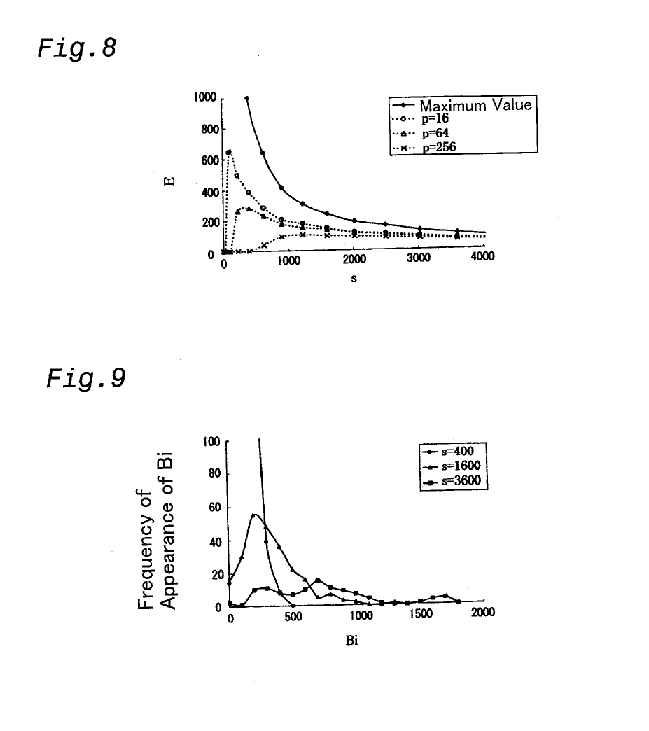

With regard to various reference values p, the number of embeddable blocks E is measured against the size s of the block Aᵢ. The result of measurement is given in FIG. 8. As clearly shown in FIG. 8, an increase in the size s of the block Aᵢ decreases the total number of divisional blocks E₀ and thus naturally reduces the number of embeddable blocks (that is, the quantity of embeddable information) E. A decrease in size s of the block Aᵢ, however, may not raise the number of embeddable blocks E. This is because the smaller size s of the block Aᵢ increases a rate ε of blocks excluded by Conditional Expression (2) as shown in FIG. 7. The rate ε is expressed by Equation (17) given below:

$$ϵ = 1 - \frac{1}{⌊ \frac{M}{m} ⌋ \times ⌊ \frac{N}{n} ⌋} \qquad ( 17 )$$

The quantity of embeddable information E is significantly affected by the type of the image. For example, the relationship between the number of black pixels Bᵢ and the frequency of its appearance is measured under the same conditions as those of FIG. 7(c) with regard to the image of Case 2 shown in FIG. 6(b). The result shown in FIG. 9 indicates the greater quantity of embeddable information. A complicated image including a greater number of black pixels Bᵢ like the binary image of FIG. 6(b) has a less leftward deviation in the graph, compared with a simpler image with a large white background. This reduces the number of excluded blocks by Conditional Expression (2) and thereby increases the quantity of embeddable information.

D-2. Complexity of Image and Effects of Embedding

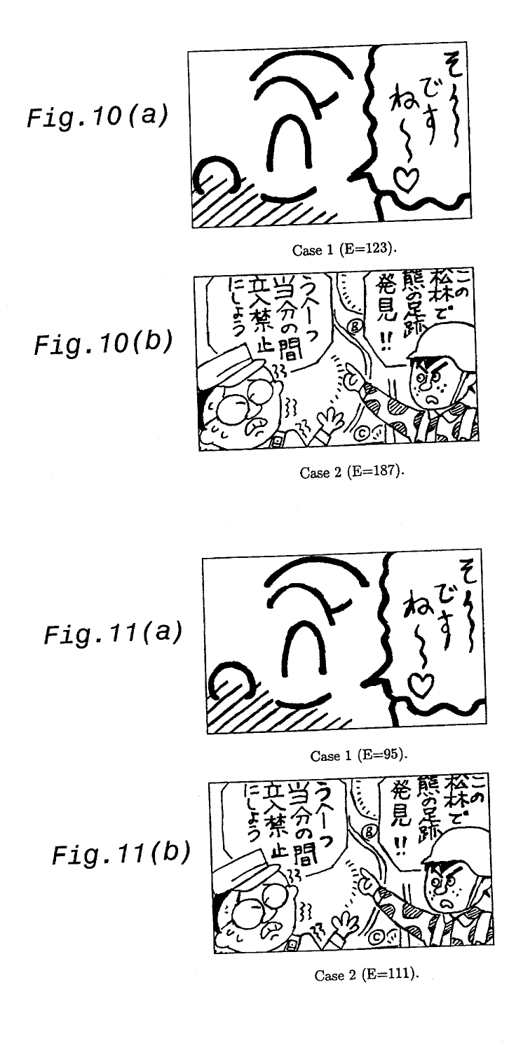

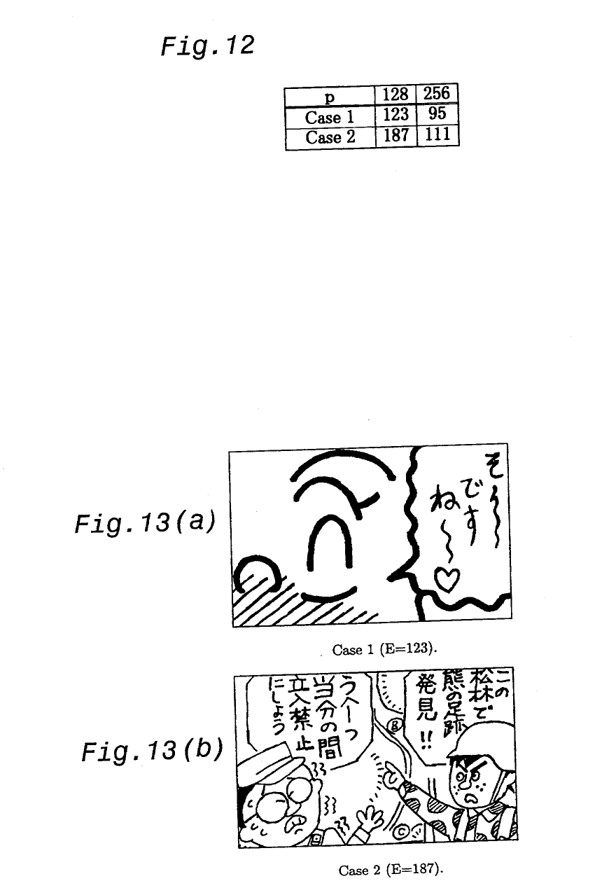

Watermark information is embedded into the binary images of Cases 1 and 2 shown in FIG. 6 according to the digital watermark embedding process of the first embodiment under the conditions of the block size s=40×40 and the reference values p=128 and p=256. Resulting images are shown in FIGS. 10 and 11. FIG. 12 shows the quantity of embeddable information E in the respective images.

The images of Cases 1 and 2 at the reference value p=256 have greater effects of embedding than those at the reference value p=128, although the quantity of embeddable information E at p=256 is less than that at p=128. This is attributable to the fact that the ratio p/s is 8% at the reference value p=128 but 16% at the reference value p=256. The larger reference value p increases the number of pixels having the varied pixel values due to embedding and thus leads to the poorer picture quality under the condition of a fixed block size s.

Comparison between FIGS. 10(a) and 10(b) and between FIGS. 11(a) and 11(b) shows that distortion of the image of Case 2 is not so inconspicuous as that of the image of Case 1. This is ascribed to the fact that the image of Case 2 has a greater number of edges and a larger high frequency component than the image of Case 1. The pixels having the varied pixel values due to embedding are accordingly dispersed in a wider area in the image of Case 2.

Watermark information is embedded into the binary images of Cases 1 and 2 shown in FIG. 6 according to the digital watermark embedding process of the second embodiment under the conditions of the block size s=40×40 and the reference value p=128. Resulting images are shown in FIG. 13.

As clearly understood from comparison between FIG. 10 and FIG. 13, it is practically impossible to find out the difference in embedding process (that is, the difference between the embedding process of the first embodiment and the embedding process of the second embodiment) based on the picture quality.

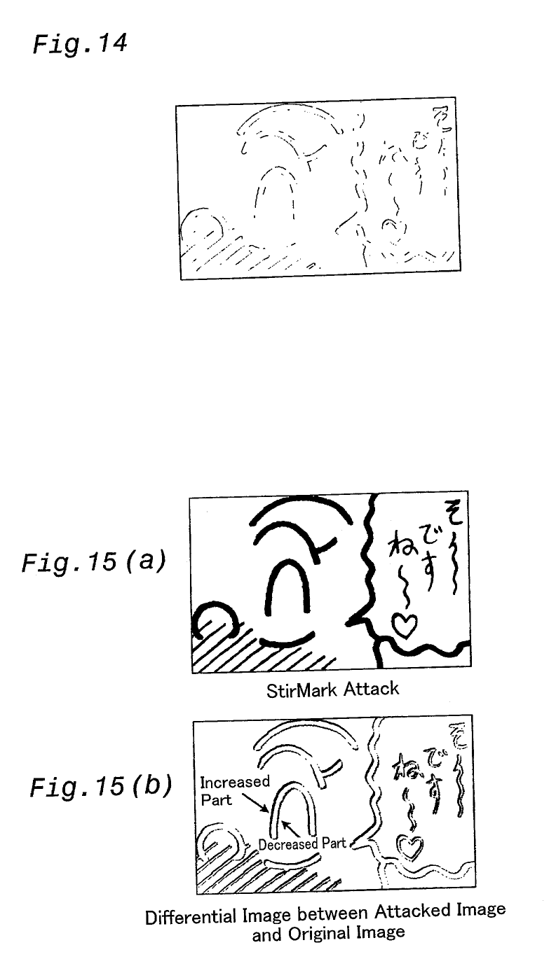

FIG. 14 shows a differential image between the original image of FIG. 6(a) and the information-embedded image of FIG. 10(a). As clearly shown in FIG. 14, the digital watermark embedding process of the embodiment restricts the place of varying the pixel values to the edges of the original image. Note that the original image is not required for extraction of the watermark information in the technique of this embodiment as described previously.

D-3. Resistance to Attacks

D-3-1. Resistance to Compressing

The binary images with the watermark information embedded therein according to the digital watermark embedding processes of the first embodiment and the second embodiment were subjected to a test on resistance to compressing by two methods, JBIG-2 that is a reversible compressing method of binary images and JPEG that is a compressing method of continuous-tone still images. The following describes the results of the test.

In the case of JBIG-2 that is the reversible compressing method, all the watermark information can be extracted from the compressed and decompressed image without any difficulties.

JPEG is generally applied to compress multi-valued images, and was used in this embodiment to test the resistance to irreversible compression. The test according to JPEG compressed the binary image at compression ratios of 10%, 8%, and 3%, binarized the respective decompressed images, and extracted the embedded watermark information from the binary images. The watermark information was accurately extracted at all the compression ratios.

D-3-2. StirMark

StirMark is a software program of attacking watermark information, which is open to public as a tool for testing attacks to watermarking. The StirMark attack carries out processes of scaling, gradation, median filtering, minute rotation, and JPEG compression in combination to destroy watermark information, while maintaining the visual picture quality.

FIG. 15(a) shows the result of a StirMark attack to the information-embedded image of FIG. 10(a) with changing parameters of StirMark, the moving distance of the center, the moving distance to the inside of the corner, and the moving distance to the outside of the corner, as default values. FIG. 15(b) shows a differential image between the attacked image and the information-embedded image of FIG. 10(a). Attacks of varying the pixel values to significantly deteriorate the picture quality of the binary image are not practical and are thus out of consideration.

In the image of FIG. 15(b), the black area represents a part of increased black pixels by the StirMark attack, whereas the gray area represents a part of decreased black pixels.

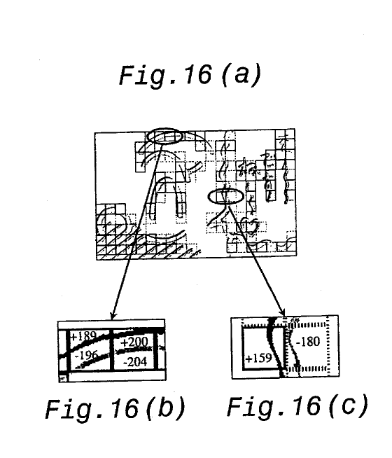

These drawings prove that the StirMark attack destroys the block synchronization. Superimposition of the relationship between the embedded data and the extracted data on the drawing of FIG. 15(b) gives FIG. 16.

In the drawing of FIG. 16, the blocks encircled by the solid lines represent places from which the watermark information is accurately extracted. The blocks encircled by the dotted lines represent places from which the embedded watermark information can not be extracted or places from which the watermark information is inaccurately extracted. Each numeral in the drawing shows a variation of black pixels in the picked-up blocks.

When the information-embedded image of FIG. 10(a) was exposed to the StirMark attack, the mean extraction rate (decoding rate) was 53.7%. There are blocks with both an increase in number of black pixels and a decrease in number of black pixels as shown in FIG. 16(b), as well as blocks with only either an increase in number of black pixels or a decrease in number of black pixels as shown in FIG. 16(c). The embedded watermark information is accurately extracted in the case of substantial offset of an increase to a decrease. The embedded watermark information is inaccurately extracted, however, in the case of only either an increase or a decrease or in the case of a significant difference between an increase and a decrease.

The setting of the reference value is p=128. Inaccurate extraction of watermark information occurs when the residual of the variation of black pixels by the reference value p is not less than (1/4)p=32.

When the information-embedded image of FIG. 13(a) was exposed to the StirMark attack, on the other hand, the mean extraction rate (decoding rate) was 61.6%. Dispersion of the converged number of black pixels using random digits enhances the resistance to the StirMark attack by about 7% and advantageously prevents the decoding attack to the secret keys (m, n, p) by total retrieval.

In some cases, however, it is difficult to accurately extract all the watermark information from the image exposed to the StirMark attack. One possible countermeasure corrects the block synchronization while iteratively embedding the watermark information. Another possible countermeasure carries out an inverse transform of the StirMark transform. By taking into account the result of FIG. 16, still another possible countermeasure limits the target of embedding watermark information to blocks that can counterbalance a variation in number of pixels due to the attack.

D-3-3. Expansion and Contraction

The information-embedded images of FIGS. 10(a) and 13(a) were exposed to 2-fold, 3-fold, and 4-fold expansions and ½-fold, ⅓-fold, and ¼-fold contractions with two image processing tools (Soft A and Soft B) and extracted watermark information from the respective processed images. The magnification represents the expansion rate or the contraction rate of both the length and the width. The image was processed with the same magnification, in order to keep the visual quality of the image.

The 2-fold expansion of the length and the width (m,n) of the block increases the number of pixels in the block to 4 times. The 3-fold expansion increases the number of pixels to 9 times. In the case of extracting the watermark information, the value obtained by multiplying the size of the original block by the expansion rate is used as the size of the block (m×n), and the value obtained by multiplying the original reference value by the square of the expansion rate is used as the reference value p. In the case of contraction, the size of the block and the reference value are recalculated in a similar manner. For example, when the contraction rate is 1/2 or 1/4, recalculation gives integral values as the size of the block (m×n) and the reference value. When the contraction rate is 1/3, however, recalculation does not give integral values. In the case of the contraction rate 1/3, the size of the block and the reference value are thus specified by Expressions

$$Size of Block : ⌊ \frac{m}{3} ⌋ \times ⌊ \frac{n}{3} ⌋ \\ Reference Value : ⌊ \frac{p}{3} ⌋ \qquad ( 18 )$$

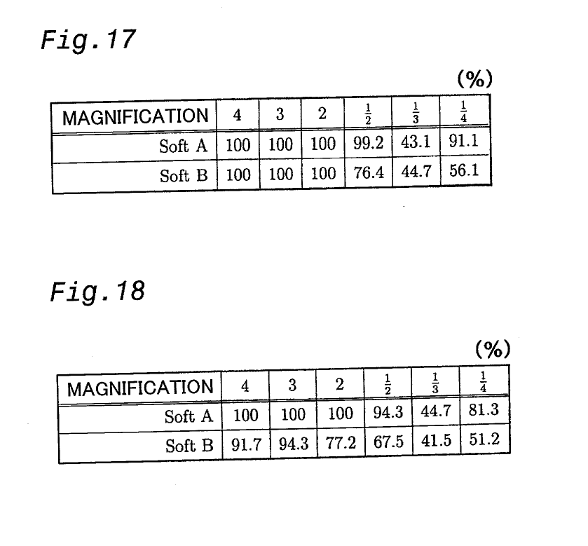

The extraction rate of the watermark information was measured at each magnification with regard to the information-embedded images of FIGS. 10(a) and 13(a). The results of the measurement are shown in FIGS. 17 and 18.

The description first regards the information-embedded image of FIG. 10(a). The expansion with either of the two tools, Soft A and Soft B enabled the watermark information to be accurately extracted, regardless of the expansion rate. In the case of contraction with Soft A to 1/2 and 1/4, the watermark information was extracted at the extraction rate of not less than 90%. The ⅓-fold contraction, however, resulted in lowering the extraction rate to 50% or less. These results may be ascribed to the effects of an error due to the cutoff in the process of recalculation of the size of the block and the reference value. The contraction with Soft B, on the other hand, caused no sufficiently high extraction rate, regardless of the contraction rate.

The variation in extraction rate according to the type of the image processing tool is attributable to the difference of the extraction and contraction method. In general, a variation in number of pixels is required to change the size of the image without varying the resolution of the image. A method of setting a representative value to keep the rate of the luminance level of pixels and a method of simple re-sampling are applicable for the variation in number of pixels. These two methods do not make a significant difference in visual effects, but give a remarkable variation in extraction rate in the digital watermark extraction process of the embodiment, which extracts the watermark information according to the number of pixels. The extraction rate decreases with an increase in contraction rate. This is because the redundancy set to the reference value increases in the case of extraction but decreases in the case of contraction. At the contraction rate of 1/3, the error due to the cutoff in the process of recalculation of the size of the block m×n and the reference value p may also affect the extraction rate.

The description then regards the information-embedded image of FIG. 13(a). The expansion with Soft A enabled the watermark information to be accurately extracted, whereas the expansion with Soft B gave the lowered extraction rate. In the case of contraction, the image of FIG. 13(a) had the lower extraction rate than the image of FIG. 10(a). Compared with the image of FIG. 10(a), the information-embedded image of FIG. 13(a) has blocks of the lower redundancy, since the adopted watermark information embedding method disperses the converged number of black pixels with random digits. This may be the reason of the lower extraction rate from the image of FIG. 13(a) than that from the image of FIG. 10(a) in the case of contraction. In the case of expansion, on the other hand, the redundancy in the image of FIG. 10(a) compensates for the variation of the image processing tool. The variation, however, affects the image of FIG. 13(a) and lowers the extraction rate of the processed image with Soft B.

D-4. Effects of First and Second Embodiments

Unlike the prior art technique, the digital watermark embedding processes of the first embodiment and the second embodiment utilize the line-work, which is characteristic of cartoons, and regard black pixel sections of line segments and pictures as areas to embed watermark information therein. In the procedures of these embodiments, the edges of the black pixel areas of the image are homogeneously expanded or contracted. This arrangement significantly reduces the visual effects on the picture quality and ensures sufficient resistance to diverse attacks.

E. Third Embodiment

In the first and the second embodiments described above, the image data of interest is binary image data. Images of a cartoon include not only black and white binary images but a large number of color images.

A third embodiment accordingly regards a process of embedding digital watermark into a color image of interest representing a cartoon and a process of extracting the embedded digital watermark.

E-1. Digital Watermark Embedding Process

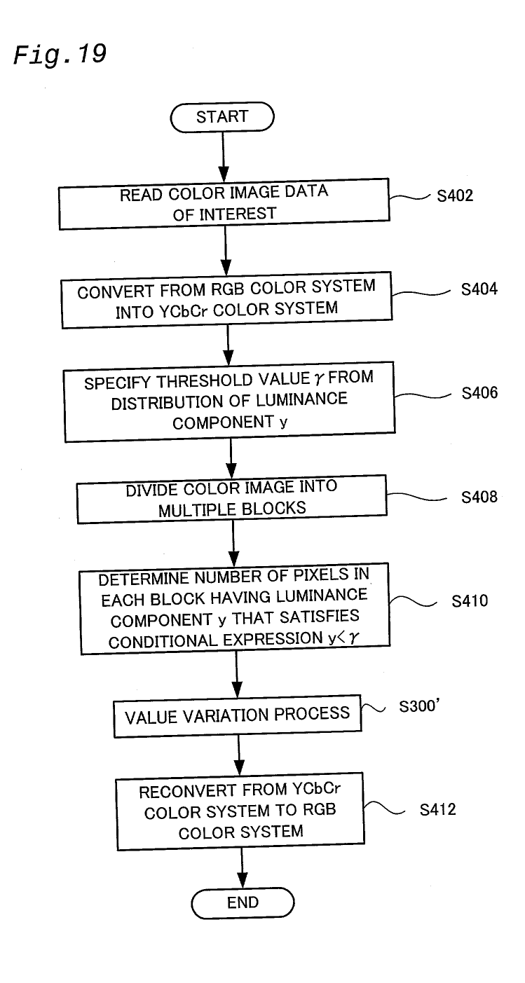

FIG. 19 is a flowchart showing a routine of the digital watermark embedding process executed in the third embodiment of the present invention. This routine is executed by the block division module 41, the pixel number computation module 42, the block decision module 43, the operation module 44, the changing pixel number computation module 45, the pixel varying module 46, and the color system conversion module 48 shown in FIG. 1.

In this embodiment, color image data representing a cartoon is stored in advance as image data of interest in the hard disk unit 36. The color image is expressed by the RGB color system.

When the program enters the digital watermark embedding routine shown in FIG. 19, the color system conversion module 48 first reads color image data of interest from the hard disk unit 36 (step S402) and converts the color image of the RGB color system into the YC_{b}Cᵣ color system (step S404). The YC_{b}Cᵣ color system is a well-known standard color system in encoding of images.

The read-out color image has a size of M×N pixels, like the binary image described above. The respective components of the color image in the RGB color system before conversion are expressed by (r,g,b), while the respective components of the color-converted color image in the YC_{b}Cᵣ color system are expressed by (y,c_{b},cᵣ).

In accordance with a concrete procedure, the color system conversion module 48 carries out color conversion from the RGB color system into the YC_{b}Cᵣ color system according to Equation (19) given below:

$$[ \begin{matrix}y \\ {c}_{b} \\ {c}_{r}\end{matrix} ] = [ \begin{matrix}0.299 & 0.587 & 0.114 \\ - 0.169 & - 0.331 & 0.500 \\ 0.500 & - 0.419 & - 0.081\end{matrix} ] [ \begin{matrix}r \\ g \\ b\end{matrix} ] \qquad ( 19 )$$

The color system conversion module 48 checks a distribution of the luminance component among the components (y,c_{b},cᵣ) in the YC_{b}Cᵣ color system, and specifies a threshold value γ used to classify pixels according to the magnitude of the luminance component (step S406).

The block division module 41 then divides the color image into blocks of m×n pixels with regard to at least the luminance component y among the components (y,c_{b},cᵣ) in the YC_{b}Cᵣ color system obtained at step S404 (step S408).

According to Equation (19), the luminance component y is expressed as Equation (20) given below:

y=0.299r+0.587g+0.114b (20)

The pixel number computation module 42 subsequently determines the number of pixels having the luminance component y that satisfies Conditional Expression (21) given below, out of all the pixels included in each divisional block Aᵢ (i=1,2,3, . . . ) (step S410).

y<γ (21)

Namely the pixel number computation module 42 determines how many pixels having the luminance component y that is less than the threshold value γ specified at step S406 are present in the block. Such pixels having the luminance component y that satisfies Conditional Expression (21), that is, the pixels having the luminance component y that is less than the threshold value γ are hereafter referred to as ‘low luminance pixels’, for convenience of explanation.

The process (step S300′) subsequent to step S410 is similar to the value variation process (step S300) shown in FIG. 5. The value variation process (step S300′) of this embodiment shown in FIG. 19 is thus not described in detail. While the black pixels are the target of the value variation process (step S300) of FIG. 5, the low luminance pixels are the target of the value variation process (step S300′) of this embodiment shown in FIG. 19. In the value variation process (step S300′) of FIG. 19, the ‘black pixels’ and the ‘pixel value’ in the description of the value variation process (step S300) of FIG. 5 should respectively be changed to the ‘low luminance pixels’ and the ‘luminance component y’.

In the value variation process (step S300) of FIG. 5, the pixel varying module 46 inverts the pixels on the edge of each line-work object, such as a line segment or a character, in the block of interest Aᵢ corresponding to the absolute value |cᵢ| of the number of changing pixels from white to black in the case of the positive number of changing pixels cᵢ and from black to white in the case of the negative number of changing pixels cᵢ at step S324 Namely the pixel values a(x,y) of the pixels on the edge are varied from ‘0’ to ‘1’ in the case of the positive number of changing pixels cᵢ and from ‘1’ to ‘0’ in the case of the negative number of changing pixels cᵢ.

In the value variation process (step S300′) of FIG. 19, on the other hand, the pixel varying module 46 varies the pixels on the edge of the line-work object in the block of interest Aᵢ corresponding to the absolute value |cᵢ| of the number of changing pixels. The procedure varies the pixels having the luminance component y that does not satisfy Conditional Expression (21) to the pixels having the luminance component y that satisfies Conditional Expression (21) in the case of the positive number of changing pixels cᵢ, while varying the pixels having the luminance component y that satisfies Conditional Expression (21) to the pixels that does not satisfy Conditional Expression (21) in the case of the negative number of changing pixels cᵢ. More specifically, the procedure varies the pixels having the luminance component y that is not less than the threshold value γ to the pixels having the luminance component y that is less than the threshold value γ in the case of the positive number of changing pixels cᵢ, while varying the pixels having the luminance component y that is less than the threshold value γ to the pixels having the luminance component y that is not less than the threshold value γ in the case of the negative number of changing pixels cᵢ.

The luminance component y among the components (y,c_{b},cᵣ) in the YC_{b}Cᵣ color system is subjected to the value variation process (step S300′) of FIG. 19, so that the watermark information is embedded with regard to the luminance component y.

The color system conversion module 48 subsequently reconverts the color image of the YC_{b}Cᵣ color system with the watermark information embedded therein with regard to the luminance component y into a color image of the original RGB color system according to Equation (22) given below (step S412):

$$[ \begin{matrix}r \\ g \\ b\end{matrix} ] = [ \begin{matrix}1.000 & - 0.001 & 1.402 \\ 1.000 & - 0.344 & - 0.714 \\ 1.000 & 1.772 & 0.001\end{matrix} ] [ \begin{matrix}y \\ {c}_{b} \\ {c}_{r}\end{matrix} ] \qquad ( 22 )$$

The program then exits from the digital watermark embedding routine shown in FIG. 19.

The digital watermark embedding process of this embodiment enables the watermark information representing copyright information to be embedded into the color image data representing a cartoon. Among the various parameters used in the digital watermark embedding process, the block size (m pixels by n pixels) and the reference value p are the secret keys in the first and the second embodiments. This embodiment additionally sets the threshold value γ for classifying the pixels according to the magnitude of the luminance component y as the secret key.

E-2. Modification of Digital Watermark Embedding Process

As described previously in Section C-2, in this embodiment, the number of changing pixels cᵢ computed by the changing pixel number computation module 45 may take negative values according to the residual bᵢ and the random number r. In the case of the negative number of changing pixels cᵢ, the pixel varying module 46 eventually varies the pixels having the luminance component y that is less than the threshold value γ, among part of the pixels in the block of interest Aᵢ, to the pixels having the luminance component y that is not less than the threshold value γ.

In the case where only the pixels having low values of the luminance component y are the pixels of interest for embedding, the variation of the luminance component y should be limited to the variation from the pixels having the luminance component y that is not less than the threshold value γ to the pixels having the luminance component y that is less than the threshold value γ.

In such cases, the procedure computes the number of changing pixels cᵢ according to either Equation (12) or Equation (13), and in the case of the negative number of changing pixels cᵢ(cᵢ<0), adds the reference value p to the computed number of changing pixels cᵢ according to Equation (15), so as to set a new number of changing pixels cᵢ. This makes all the number of changing pixels cᵢ not less than 0. The variation of the luminance component y is accordingly limited to the variation from the pixels having the luminance component y that is not less than the threshold value γ to the pixels having the luminance component y that is less than the threshold value γ.

In the case where only the pixels having high values of the luminance component y are the pixels of interest for embedding, on the contrary, when the computed number of changing pixels cᵢ is positive, the procedure subtracts the reference value p from the computed number of changing pixels cᵢ to set a new number of changing pixels cᵢ. This makes all the number of changing pixels cᵢ not greater than 0. The variation of the luminance component y is accordingly limited to the variation from the pixels having the luminance component y that is less than the threshold value γ to the pixels having the luminance component y that is not less than the threshold value γ.

Similar modifications to those discussed previously as the first through the fourth modifications of the digital watermark embedding process of the second embodiment are also applicable to the digital watermark embedding process of the third embodiment.

E-3. Digital Watermark Extraction Process

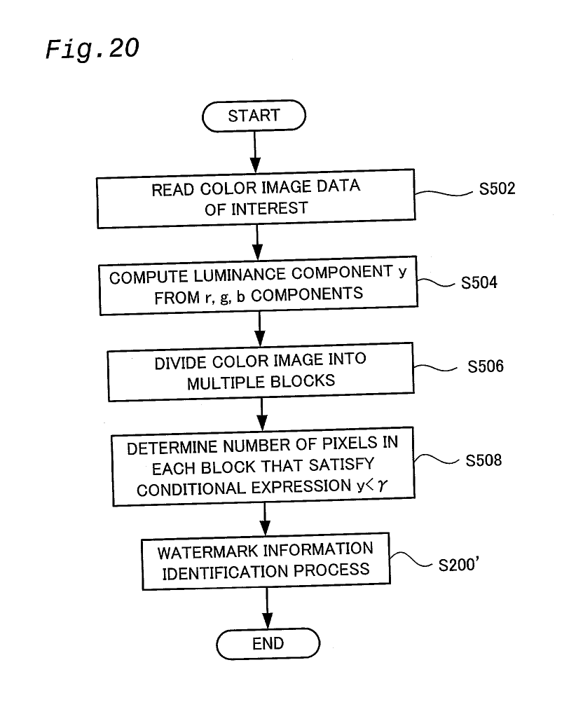

FIG. 20 is a flowchart showing a routine of the digital watermark extraction process executed in the third embodiment of the present invention. This routine is executed by the block division module 41, the pixel number computation module 42, the block decision module 43, the operation module 44, the information identification module 47, and the color system conversion module 48 shown in FIG. 1.

In this embodiment, color image data with watermark information embedded therein by the digital watermark embedding process shown in FIG. 19 is stored in advance as image data of interest in the hard disk unit 36. The color image is expressed by the RGB color system.

When the program enters the digital watermark extraction routine shown in FIG. 20, the color system conversion module 48 first reads color image data of interest with watermark information embedded therein from the hard disk unit 36 (step S502) and calculates the luminance component y in the YC_{b}Cᵣ color system from the components (r,g,b) of the color image in the RGB color system according to Equation (20) given above (step S504).

The block division module 41 specifies the size of each block (m pixels by n pixels) according to separate information of secret keys used in the process of embedding the watermark information into the color image data, and divides the color image into multiple blocks having the size of m×n pixels with regard to the luminance component y calculated at step S504 (step S506).

The pixel number computation module 42 subsequently specifies the threshold value γ from the information of the secret key, and determines the number of pixels having the luminance component y that satisfies Conditional Expression (21) given above (that is, low luminance components) out of all the pixels included in each divisional block Aᵢ (i=1,2,3, . . . ), based on the threshold value γ (step S508).

The process (step S200′) subsequent to step S508 is similar to the watermark information identification process (step S200) shown in FIG. 4. The watermark information identification process (step S200′) of this embodiment shown in FIG. 20 is thus not described in detail. While the black pixels are the target of the watermark information identification process (step S200) of FIG. 4, the low luminance pixels are the target of the watermark information identification process (step S200′) of this embodiment shown in FIG. 20. In the watermark information identification process (step S200′) of FIG. 20, the ‘black pixels’ in the description of the watermark information identification process (step S200) of FIG. 4 should be changed to the ‘low luminance pixels’.

The watermark information identification process (step S200′) enables the embedded watermark information dᵢ to be extracted from each embeddable block of the color image.

The digital watermark extraction process described above extracts the watermark information embedded in the color image data representing a cartoon and takes out the copyright information of the cartoon. This procedure of the embodiment does not require an original image but enables extraction of the embedded watermark information with the secret keys.

In this embodiment, the number of blocks E′ determined as embeddable blocks at the time of extracting watermark information may not be coincident with the number of blocks E determined as embeddable blocks at the time of embedding watermark information, due to noise and malicious attacks by any third person.

F. Concrete Examples and Summary of Third Embodiment

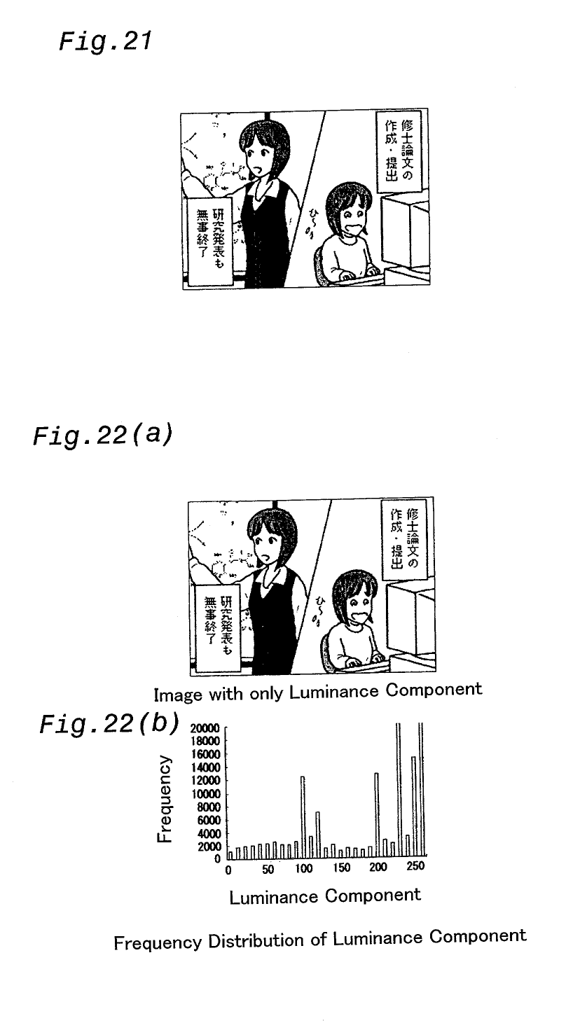

The following describes a concrete example of embedding watermark information into a color image, which is one frame of a four-frame cartoon (Sanki: Kimi ga icchan !, URL: http://www.4koma.com/access/9904/icchan/al_{—}35.htm) shown in FIG. 21. This color image has a size of 500×350 pixels and 8 bits (256 tones) with regard to each color in the RGB color system. In the description below, the number of low luminance pixels is expressed as Xᵢ.

The color image shown in FIG. 21 is subjected to conversion from the RGB color system to the YC_{b}Cᵣ color system according to Equation (19) given above. FIG. 22(a) shows an image with only the luminance component, and FIG. 22(b) shows the frequency of appearance of each value of the luminance component y in the image.

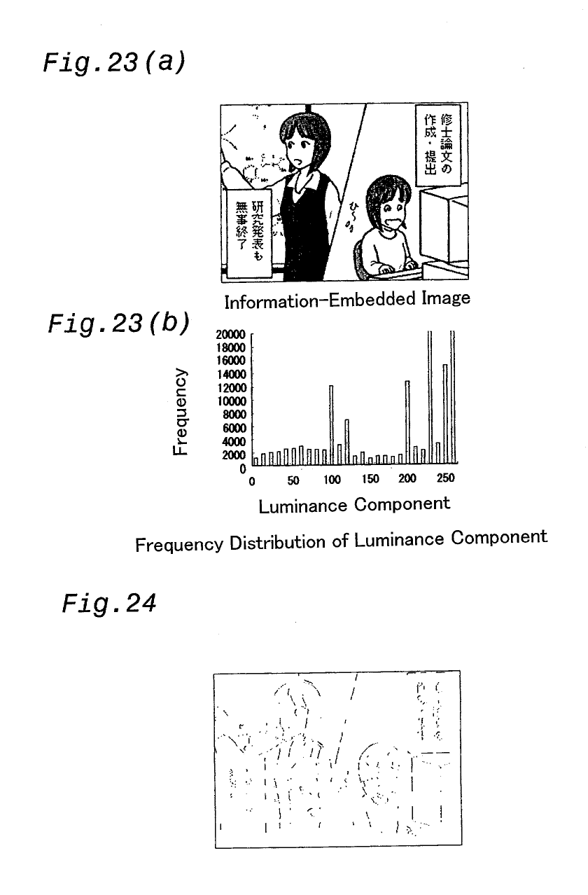

The threshold value γ is set equal to 80. This setting specifies pixels having relatively low values of the luminance component y as the ‘low luminance pixels’. The watermark information is embedded in the image shown in FIG. 22(a) under the conditions of the block dimensions m=30, n=30, and the reference value p=32. The resulting information-embedded image is shown in FIG. 23(a). FIG. 23(b) shows the frequency of appearance of each value of the luminance component y in the information-embedded image.

As clearly understood from FIGS. 22 and 23, comparison between the original image and the information-embedded image does not show any significant difference in visual effects and has no substantial variation in frequency of appearance of each value of the luminance component y.

FIG. 24 shows a differential image between the color image of FIG. 21 and the information-embedded image of FIG. 23(a). There is a variation in edge of the luminance in this differential image. This proves that the watermark information is embedded.

F-1. Quantity of Embeddable Information

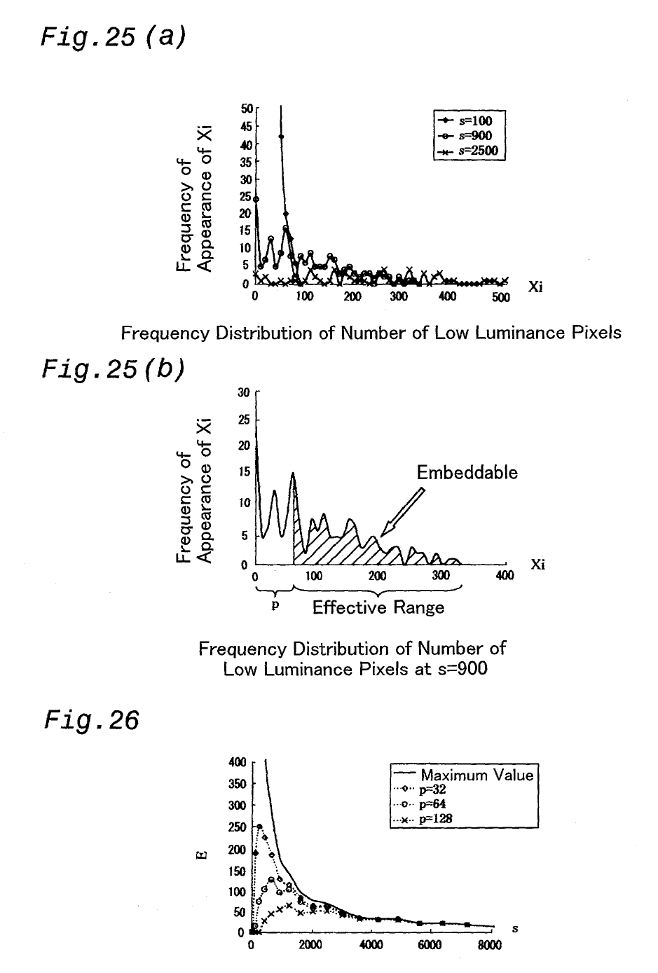

FIG. 25(a) shows the relationship between the number of low luminance pixels Xᵢ and its frequency of appearance in the color image of FIG. 21 with regard to various sizes of the block Aᵢ s=100, 900, and 2500. FIG. 25(b) specifically shows the relationship between the number of low luminance pixels Xᵢ and its frequency of appearance at the size of the block Aᵢ s=900. A hatched area in FIG. 25(b) corresponds to the number of embeddable blocks (that is, the quantity of embeddable information) E at the reference value p. An area of the side p on the left of the hatched area corresponds to a block set to prohibit embedding of watermark information and thereby prevent deterioration of the picture quality. The distributions show that a reduction in size s of the block Aᵢ at a fixed reference value p increases the number of blocks that do not fulfil Conditional Expression (2).

With regard to various reference values p, the number of embeddable blocks E is measured against the size s of the block Aᵢ. The result of measurement is given in FIG. 26. As clearly shown in FIG. 26, an increase in size s of the block Aᵢ decreases the total number of divisional blocks E₀ and thus naturally reduces the number of embeddable blocks (that is, the quantity of embeddable information) E. A decrease in size s of the block Aᵢ, however, may not raise the number of embeddable blocks E. This is because the smaller size s of the block Aᵢ increases the rate ε of blocks excluded by Conditional Expression (2) as shown in FIG. 25.

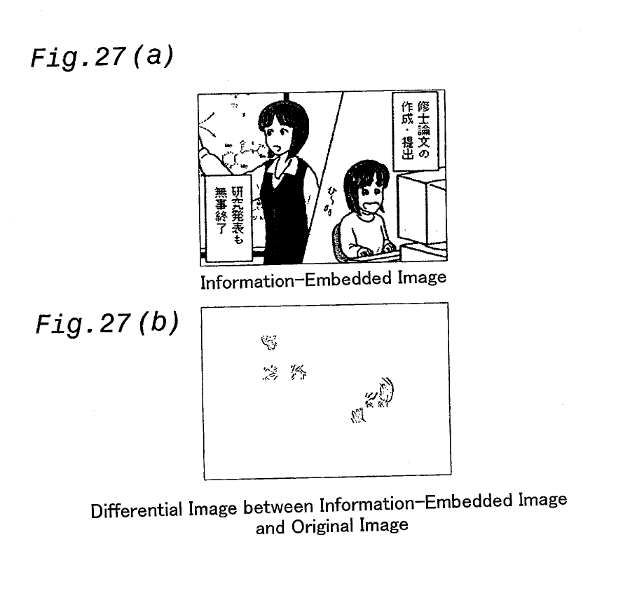

The picture quality is more significantly affected by the rate of the reference value p to the size s of the block Aᵢ than by the quantity of embedded information. Watermark information is embedded into the image of FIG. 22(a) by changing only the reference value p to 256 from the value in the case of the information-embedded image of FIG. 23(a) (while the dimensions of the block m=30 and n=30 are unchanged). FIG. 27(a) shows a resulting information-embedded image, and FIG. 27(b) shows a differential image between the information-embedded image and the original image.

The quantity of embedded information is 127 bits in the information-embedded image of FIG. 23(a), and is 7 bits in the information-embedded image of FIG. 27(a). The significantly less quantity of embedded information, however, remarkably affects the picture quality of the information-embedded image of FIG. 27(a). As clearly understood from the differential images of FIG. 24 and FIG. 27(b), an increase in reference value p increases the mean number of changing pixels and reduces the number of blocks that are object of the changing. This results in a local change of the image and gives some odd feeling in visual effects. The dimensions m×n of the block and the reference value p should thus be selected by considering these factors.

F-2. Effects of Third Embodiment

The digital watermark embedding method of the third embodiment specifies pixels of and over a preset luminance among the pixels constituting a character or a picture in a cartoon and regards the number of such pixels as an area to embed watermark information therein. The procedure of the embodiment homogeneously expands or contracts edges of the cartoon defined by a variation in luminance and embeds watermark information, thus having less visual effects on the picture quality.

G. Fourth Embodiment

The technique of the third embodiment converts the color image of the RGB color system into the YC_{b}Cᵣ color system and utilizes the luminance component y for embedding watermark information. Another application may utilize a predetermined color vector for embedding watermark information into a color image. Digital watermark embedding and extraction processes based on this technique are described below as a fourth embodiment.

G-1. Digital Watermark Embedding Process

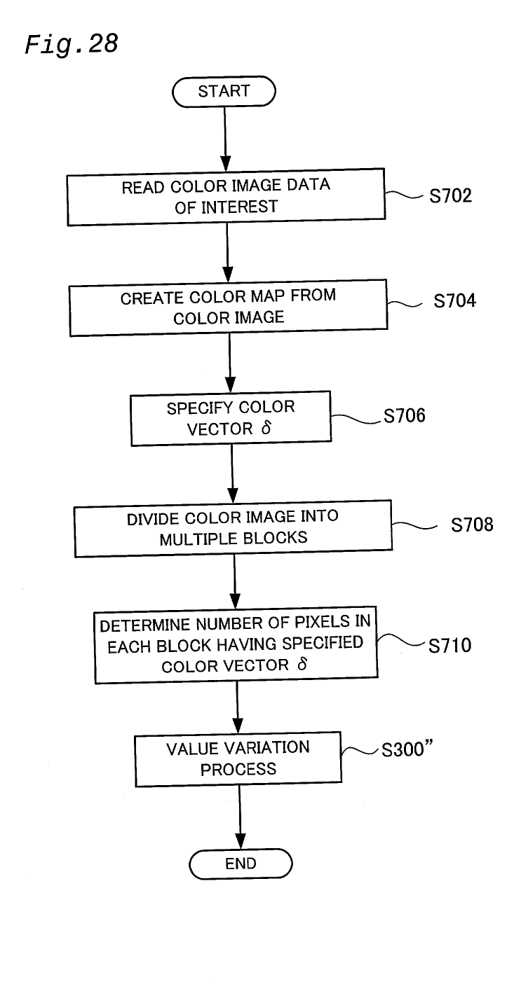

FIG. 28 is a flowchart showing a routine of the digital watermark embedding process executed in the fourth embodiment of the present invention. This routine is executed by the block division module 41, the pixel number computation module 42, the block decision module 43, the operation module 44, the changing pixel number computation module 45, the pixel varying module 46, and the color vector specification module 49 shown in FIG. 1.

In this embodiment, color image data representing a cartoon is stored in advance as image data of interest in the hard disk unit 36. The color image is expressed by the RGB color system, and a color map of this color image consists of S colors. Namely each of the S colors is expressed by color vectors of R, G, and B.

When the program enters the digital watermark embedding routine shown in FIG. 28, the color vector specification module 49 first reads color image data of interest from the hard disk unit 36 (step S702) and examines the colors used in the color image to create a color map (step S704). The color vector specification module 49 then specifies a color vector δ as an object of embedding watermark information in the color map (step S706). The block division module 41 divides the color image into multiple blocks of m×n pixels (step S708). The pixel number computation module 42 subsequently determines the number of pixels having the color vector δ specified at step S706 in each divisional block Aᵢ (i=1,2,3, . . . ) (step S710). Namely the pixel number computation module 42 determines how many pixels having the specified color vector δ are present in the block of interest Aᵢ.

The process (step S300″) subsequent to step S710 is similar to the value variation process (step S300) shown in FIG. 5. The value variation process (step S300″) of this embodiment shown in FIG. 28 is thus not described in detail. While the black pixels are the target of the value variation process (step S300) of FIG. 5, the pixels of the specified color vector δ are the target of the value variation process (step S300″) of this embodiment shown in FIG. 28. In the value variation process (step S300″) of FIG. 28, the ‘black pixels’ in the description of the value variation process (step S300) of FIG. 5 should be changed to the ‘pixels of the specified color vector δ’.

In the value variation process (step S300) of FIG. 5, the pixel varying module 46 inverts the pixels on the edge of each line-work object, such as a line segment or a character, in the block of interest Aᵢ corresponding to the absolute value |cᵢ| of the number of changing pixels from white to black in the case of the positive number of changing pixels cᵢ and from black to white in the case of the negative number of changing pixels cᵢ at step S324 Namely the pixel values a(x,y) of the pixels on the edge are varied from ‘0’ to ‘1’ in the case of the positive number of changing pixels cᵢ and from ‘1’ to ‘0’ in the case of the negative number of changing pixels cᵢ.

In the value variation process (step S300″) of FIG. 28, on the other hand, the pixel varying module 46 gives a change to the edge defined by the pixels having the specified color vector δ and those not having the specified color vector δ in the block of interest Aᵢ corresponding to the absolute value |cᵢ| of the number of changing pixels. The procedure varies the pixels not having the specified color vector δ to the pixels having the specified color vector δ in the case of the positive number of changing pixels cᵢ, while varying the pixels having the specified color vector δ to the pixels not having the specified color vector δ in the case of the negative number of changing pixels cᵢ. More specifically, the procedure varies the RGB values (that is, the pixel values) of the pixels not having the specified color vector δ to the RGB values of the specified color vector δ in the case of the positive number of changing pixels cᵢ, while varying the RGB values (that is, the pixel values) of the pixels having the specified color vector δ to RGB values different from those of the specified color vector δ in the case of the negative number of changing pixels cᵢ.

The value variation process (step S300″) of FIG. 28 is executed for the specified color vector δ in the color map of S colors, so that the watermark information is embedded with regard to the specified color vector δ. The program then exits from the digital watermark embedding routine of FIG. 28.

The digital watermark embedding process of this embodiment enables the watermark information representing copyright information to be embedded into the color image data representing a cartoon with regard to the predetermined color vector. Among the various parameters used in the digital watermark embedding process, the block size (m pixels by n pixels) and the reference value p are the secret keys in the first and the second embodiments. This embodiment additionally sets the specified color vector δ as the secret key.

Similar modifications to those discussed previously as the first through the fourth modifications of the digital watermark embedding process of the second embodiment are also applicable to the digital watermark embedding process of the fourth embodiment.

G-2. Digital Watermark Extraction Process

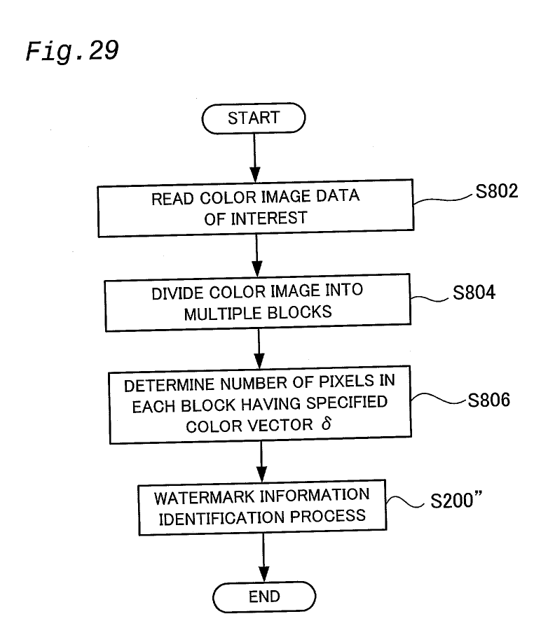

FIG. 29 is a flowchart showing a routine of the digital watermark extraction process executed in the fourth embodiment of the present invention. This routine is executed by the block division module 41, the pixel number computation module 42, the block decision module 43, the operation module 44, and the information identification module 47 shown in FIG. 1.

In this embodiment, color image data with watermark information embedded therein by the digital watermark embedding process shown in FIG. 28 is stored in advance as image data of interest in the hard disk unit 36. The color image is expressed by the RGB color system, and the color map of this color image consists of S colors.

When the program enters the digital watermark extraction routine shown in FIG. 29, the block division module 41 first reads color image data of interest with watermark information embedded therein from the hard disk unit 36 (step S802). The block division module 41 then specifies the size of each block (m pixels by n pixels) according to separate information of secret keys used in the process of embedding the watermark information into the color image data, and divides the color image into multiple blocks having the size of m×n pixels (step S804).

The pixel number computation module 42 subsequently extracts the specified color vector δ from the information of the secret key, and determines the number of pixels having the specified color vector δ out of all the pixels included in each divisional block Aᵢ (i=1,2,3, . . . ), based on the specified color vector δ (step S806).

The process (step S200″) subsequent to step S806 is similar to the watermark information identification process (step S200) shown in FIG. 4. The watermark information identification process (step S200″) of this embodiment shown in FIG. 29 is thus not described in detail. While the black pixels are the target of the watermark information identification process (step S200) of FIG. 4, the pixels having the specified color vector δ are the target of the watermark information identification process (step S200″) of this embodiment shown in FIG. 29. In the watermark information identification process (step S200″) of FIG. 29, the ‘black pixels’ in the description of the watermark information identification process (step S200) of FIG. 4 should be changed to the ‘pixels having the specified color vector δ’.

The watermark information identification process (step S200″) enables the embedded watermark information dᵢ to be extracted from each embeddable block of the color image.

The digital watermark extraction process described above extracts the watermark information embedded in the specified color vector of the color image data representing a cartoon and takes out the copyright information of the cartoon. This procedure of the embodiment does not require an original image but enables extraction of the embedded watermark information with the secret keys.

In this embodiment, the number of blocks E′ determined as embeddable blocks at the time of extracting watermark information may not be coincident with the number of blocks E determined as embeddable blocks at the time of embedding watermark information, due to noise and malicious attacks by any third person.

G-3. Modification of Digital Watermark Embedding Process

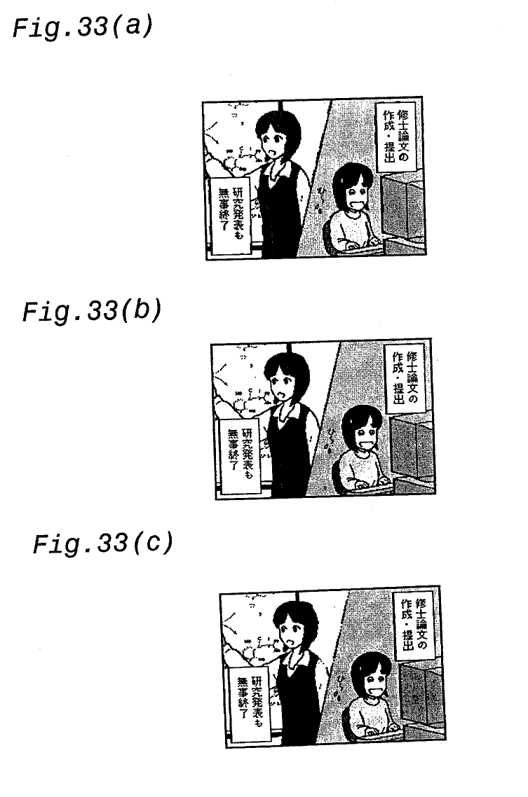

In the above embodiment, only one color vector (that is, the specified color vector δ) is the object of embedding watermark information. In some cases, the specified color vector may be assumable as shown in FIGS. 33(a) and 33(b) described later.

In order to solve this problem, one possible modification varies the color vector (the specified color vector δ) of each block as the object of embedding watermark information at random.

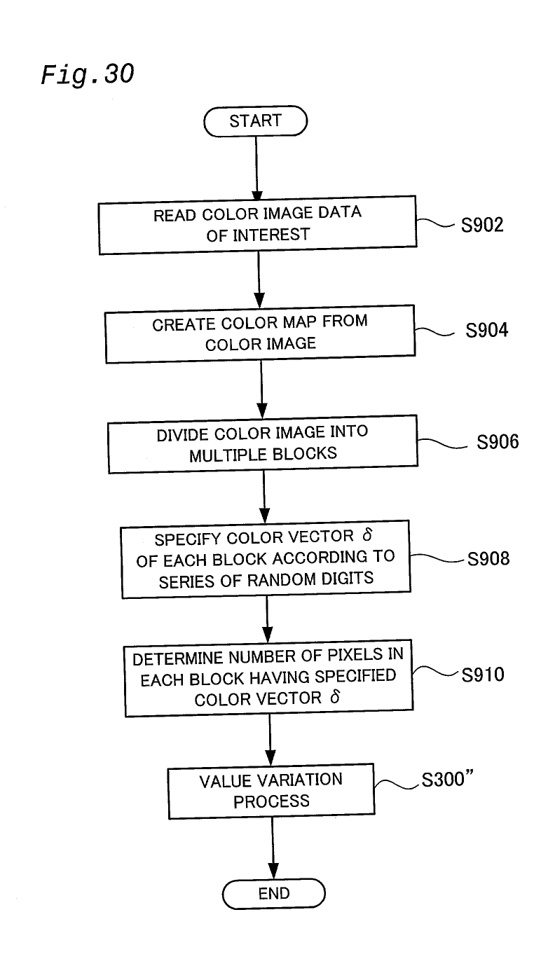

FIG. 30 is a flowchart showing a modified digital watermark embedding process in a modified example of the fourth embodiment.

When the program enters the digital watermark embedding routine shown in FIG. 30, the color vector specification module 49 first reads color image data of interest from the hard disk unit 36 (step S902) and examines the colors used in the color image to create a color map (step S904). The block division module 41 divides the color image into multiple blocks of m×n pixels (step S906). The color vector specification module 49 subsequently refers to the color map to extract the number of colors used in the color image, generates a series of random digits in the range of the extracted number of colors, and specifies the color vector δ in each divisional block Aᵢ (i=1,2,3 . . . ) as the object of embedding watermark information out of the color map according to the series of random digits (step S908). For example, in the case of a color image consisting of 13 colors, the number of colors is 13 and the series of random digits should be in the range of 0 to 12. The color vector δ is specified at random among the 13 colors. The pixel number computation module 42 determines the number of pixels having the color vector δ specified at random in each divisional block Aᵢ (i=1,2,3, . . . ) (step S910).

The process (step S300″) subsequent to step S910 is similar to the value variation process (step S300) of FIG. 5, in the same manner as the routine of FIG. 28.

The procedure of this embodiment sets the dimensions of each block (m pixels by n pixels) and the reference value p among the parameters used in the digital watermark embedding process, as well as the color map and the series of random digits as the secret keys.

Extraction of the embedded watermark information follows the digital watermark extraction process shown in FIG. 29. The block division module 41 first reads color image data of interest with watermark information embedded therein from the hard disk unit 36 (step S802). The block division module 41 then specifies the size of each block (m pixels by n pixels) according to separate information of secret keys used in the process of embedding the watermark information into the color image data, and divides the color image into multiple blocks having the size of m×n pixels (step S804).

The pixel number computation module 42 subsequently extracts the color map and the series of random digits from the information of the secret key, sets the specified color vector δ corresponding to the color map and the series of random digits in each divisional block Aᵢ (i=1,2,3, . . . ), and determines the number of pixels having the specified color vector δ out of all the pixels included in each block (step S806). The process (step S200″) subsequent to step S806 is similar to the watermark information identification process (step S200) of FIG. 4 as described previously.

The procedure of this modified example varies the specified color vector δ of each block at random and effectively prevents any third person from estimating the color vector specified as the object of embedding watermark information and thereby extracting the watermark information.

H. Concrete Examples and Summary of Fourth Embodiment

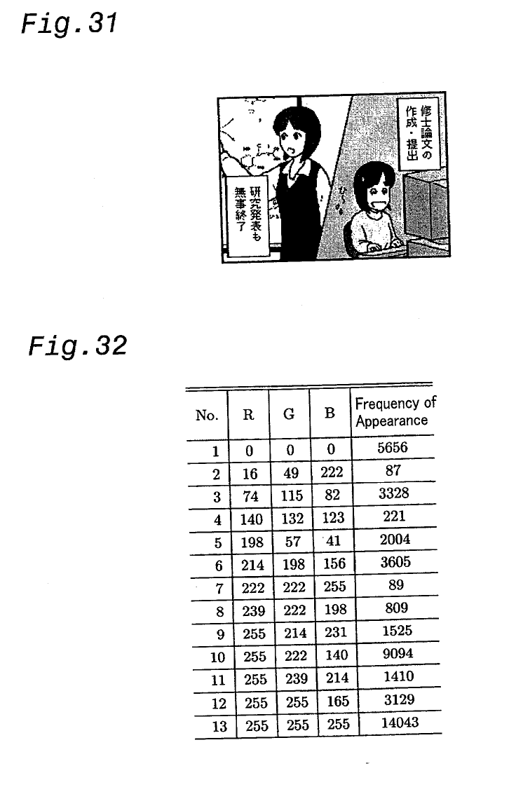

The following describes a concrete example of embedding watermark information into the color image, which is used in the concrete example of the third embodiment and is one frame of the four-frame cartoon shown in FIG. 31. This color image has a size of 250×180 pixels, which is the image size used in personal digital assistants and portable terminals, and includes 8-bit data with regard to each color in the RGB color system. The color map of this color image consists of 13 colors (S=13) as shown in FIG. 32.

In the color map of FIG. 32, the 13 colors are expressed as No. 1 through No. 13 and each color vector is defined by the R, G, and B values. FIG. 32 also shows the frequency of appearance of each color vector in the color image of FIG. 31.

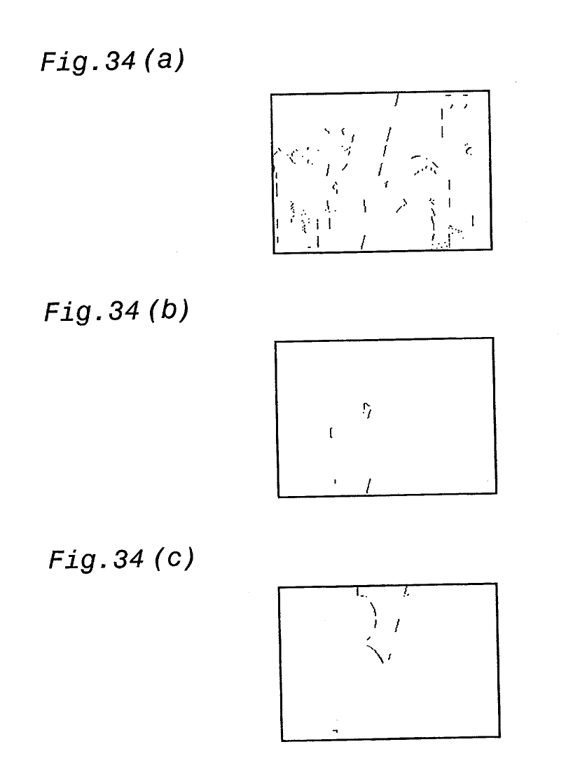

A maximum possible quantity of watermark information is embedded into an image area of each of the 13 color vectors in the color image of FIG. 31 under the conditions of m=20, n=20, and p=32. FIG. 33 shows resulting information-embedded images. FIG. 33(a) shows the case in which the specified color vector δ is the No. 1 color, FIG. 33(b) the case in which the specified color vector δ is the No. 3 color, and FIG. 33(c) the case in which the specified color vector δ is the No. 12 color. FIG. 34 shows differential images between the information-embedded images of FIG. 33 and the original image of FIG. 31. FIG. 34(a) shows the case in which the specified color vector δ is the No. 1 color, FIG. 34(b) the case in which the specified color vector δ is the No. 3 color, and FIG. 34(c) the case in which the specified color vector δ is the No. 12 color. These drawings show that only the pixels having the specified color vector δ are changed.

H-1. Quantity of Embeddable Information

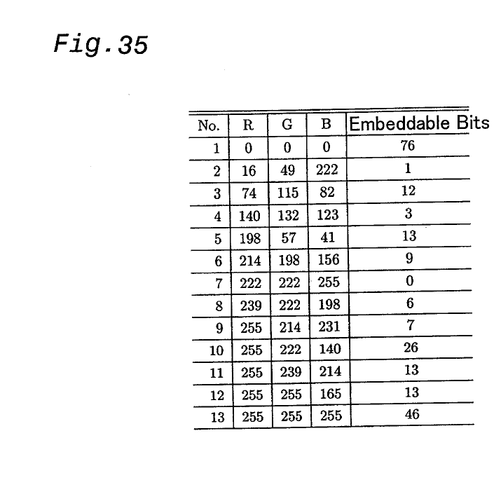

FIG. 35 shows the quantity of embeddable information into the image area of each color vector. Comparison between FIGS. 32 and 35 shows that the quantity of embeddable information depends not only the number of pixels having the color vector of the embedding object (the specified color vector δ) in the color image but its distribution, the block size, and the threshold value. The picture quality of the image is significantly affected and varied by the quantity of embedded information and the color vector of the embedding object.

H-2. Embedding into Multiple Colors

As described above, when only one color vector (that is, the specified color vector δ) is the object of embedding watermark information, the specified color vector may be assumable as shown in FIGS. 33(a) and 33(b). The preferable procedure accordingly varies the color vector (the specified color vector δ) as the object of embedding watermark information in each block at random and embeds the watermark information into multiple colors as discussed above with reference to FIG. 30. This effectively prevents any third person from estimating the specified color vector.

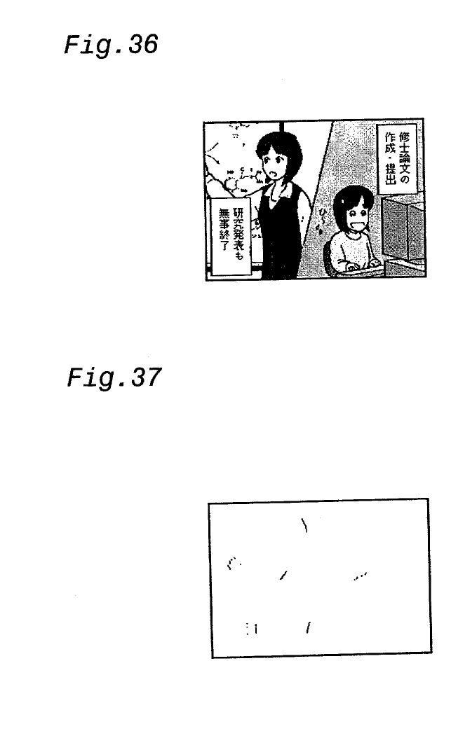

For example, watermark information is embedded into the color image of FIG. 31 under the conditions of m=20, n=20, and p=32, while the color vector (the specified color vector δ) as the object of embedding watermark information is varied at random among the 13 colors. FIG. 36 shows a resulting information-embedded image. FIG. 37 shows a differential image between the information-embedded image of FIG. 36 and the original image of FIG. 31. The information-embedded image shown in FIG. 36 has 20-bit watermark information embedded therein. The quantity of embedded information is varied by the series of random digits used in the process of embedding the watermark information. Embedding of watermark information was carried out with the varying series of random digits. The estimated mean quantity of embeddable watermark information in the color image of FIG. 31 is 17.5 bits. Comparison between FIGS. 33 and 36 shows that the latter information-embedded image (that is, the case of varying the specified color vector at random) has less distortion of the picture quality. As clearly understood from FIG. 37, the random variation of the specified color vector causes a dispersion of the colors as the object of embedding watermark information, thus making it difficult to specify the positions of embedding the watermark information.

H-3. Resistance to Attacks

H-3-1. Resistance to Compressing

The color image of restricted colors has the advantage that color information of each pixel is expressible with a less number of bits. GIF format conversion is a known data compression method utilizing this advantage. Compression of the color image with the watermark information embedded therein by this conversion technique reduced the quantity of data to 22.5% of the original image. This conversion is reversible coding, so that the watermark information is completely extractable from the color image exposed to compression and decompression.

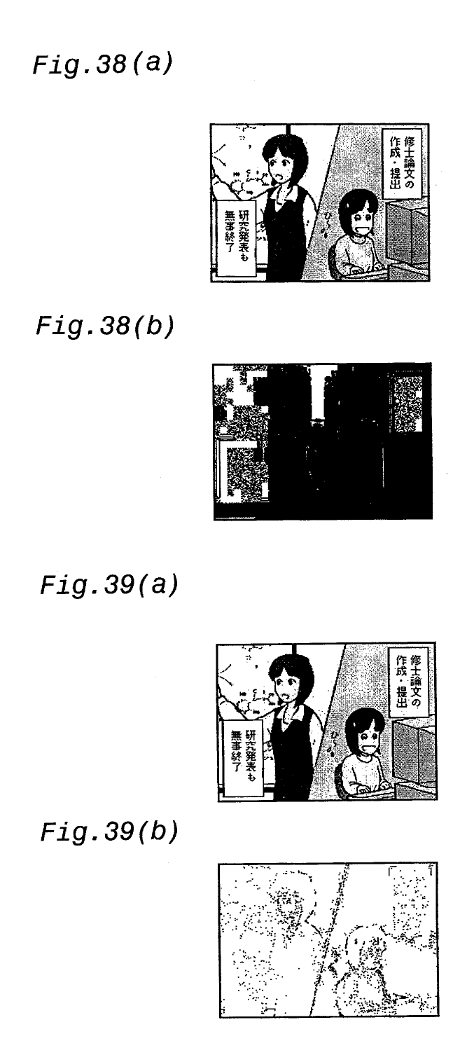

The color image with the watermark information embedded therein was also subjected to JPEG compression, a known compression technique for natural images. The JPEG compression reduced the quantity of data to 12% of the original image. The watermark information was extracted from the color image exposed to the compression and the decompression. The mean extraction rate of the watermark information was 8.1%. The JPEG compression changes the pixel values to multiple tones, so as to reduce the number of pixels having the color vector of the embedding object (the specified color vector δ) in each block. The result of the JPEG compression is shown in FIG. 38. FIG. 38(a) shows a color image after the JPEG compression and decompression, and FIG. 38(b) shows a differential image between the color image after the JPEG compression and decompression and the original image.

The variation in number of color vectors included in the color image before and after the JPEG compression was checked. While the color image before the JPEG compression was defined by 13 colors, the color image after the JPEG compression used more than 11,000 colors. The color image after the JPEG compression was subjected to color subtraction, which utilizes the least squares method and substitutes the colors of the compressed image with the colors on the color map having close color space vectors. This improved the mean extraction rate of the watermark information to 64.8%. The result of the color subtraction is shown in FIG. 39. FIG. 39(a) shows a color image after the color subtraction, and FIG. 39(b) shows a differential image between the color image after the color subtraction and the original image. It is accordingly expected that stricter application of the color subtraction further improves the extraction rate of the watermark information.

H-3-2. StirMark

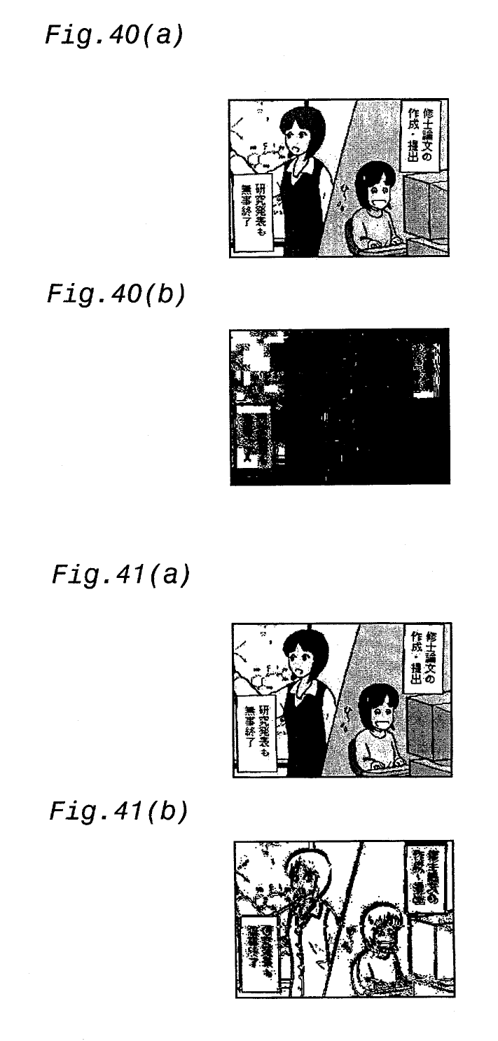

FIG. 40 shows the result of a StirMark attack to the information-embedded image of FIG. 36 with changing parameters of StirMark, the moving distance of the center (−b), the moving distance to the inside of the corner (−i), the moving distance to the outside of the corner (−o), and the variation in pixel (−d), as default values. FIG. 40(a) shows a color image after the StirMark attack, and FIG. 40(b) shows a differential image between the color image after the StirMark attack and the original image. This result shows that the StirMark attack distorts the image and changes the pixels. The mean extraction rate of he watermark information from this color image was as low as 5.2%. As in the case of the JPEG compression, the color image after the StirMark attack was subjected to the color subtraction process described above. This improved the extraction rate of the watermark information to 52.1%. The result is shown in FIG. 41. Unlike the JPEG compression, the StirMark attack gives a geometrical change. It is accordingly difficult to extract all the pieces of watermark information by the color subtraction process alone. Possible countermeasures include a technique of iteratively inserting he watermark information, block correction, and inverse transform of the StirMark attack transform.

I. Fifth Embodiment

In the first and the second embodiments described above, the image data of interest is binary image data. Images of a cartoon include not only the binary images but a large number of multi-valued images.

A fifth embodiment accordingly regards a process of embedding digital watermark into a multi-valued image of interest representing a cartoon and a process of extracting the embedded digital watermark.

I-1. Digital Watermark Embedding Process

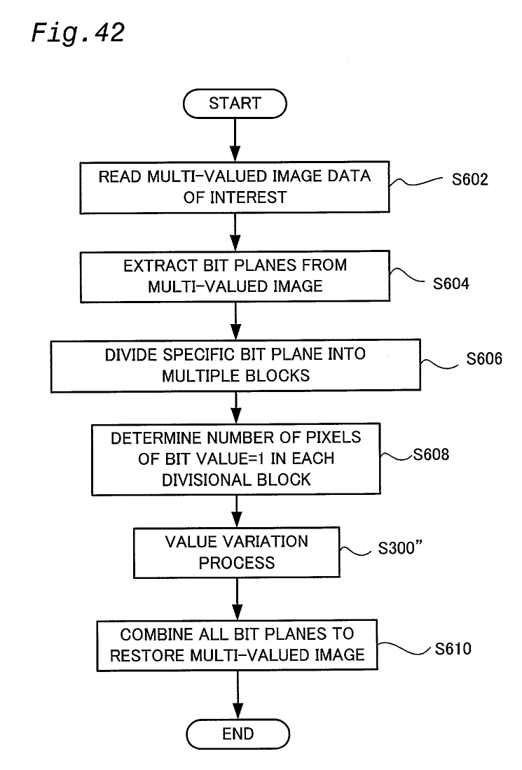

FIG. 42 is a flowchart showing a routine of the digital watermark embedding process executed in the fifth embodiment of the present invention. This routine is executed by the block division module 41, the pixel number computation module 42, the block decision module 43, the operation module 44, the changing pixel number computation module 45, the pixel varying module 46, the bit plane extraction module 49, and the bit plane composition module 50 shown in FIG. 1.

In this embodiment, multi-valued image data representing a cartoon is stored in advance as image data of interest in the hard disk unit 36.

When the program enters the digital watermark embedding routine shown in the flowchart of FIG. 42, the bit plane extraction module 49 first reads multi-valued image data of interest from the hard disk unit 36 (step S602), and extracts bit planes from the read-out multi-valued image (step S604).

Each of pixel values a(x,y) constituting a read-out multi-valued image G is expressed by Equation (23) given below:

a(x,y)=a_{d-1}(x,y)·2^{d-1}+a_{d-2}(x,y)·2^{d-2}+ . . . +a₀(x,y)·2⁰ (23)

0≦x≦M−1,0≦y≦N−1

where d represents a bit number of the multi-valued image, and aⱼ(x,y) (0≦j≦d−1) denotes a bit value with a weight of 2^{j} when the pixel value a(x,y) is expressed in binary notation.

A plane Gⱼ defined by the bit value aⱼ(x,y) is called a bit plane and is expressed by Expression (24) given below:

Gⱼ={aⱼ(x,y)|0≦x≦M−1;0≦y≦N−1} (24)

0≦j≦d−1

For example, when the bit number d of the read-out multi-valued image data is 4, there are four bit planes G₀, G₁, G₂, and G₃ in this order from the lower bit to the upper bit.

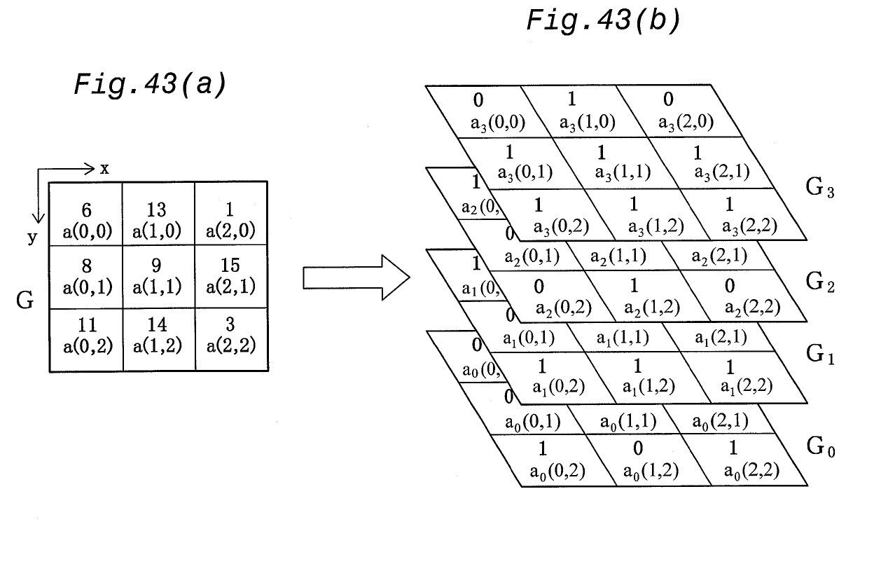

FIG. 43 shows four bit planes extracted from 4-bit multi-valued image data. FIG. 43(a) shows a multi-valued image G expressed by the 4-bit multi-valued image data, and FIG. 43(b) shows four bit planes G₀, G₁, G₂, and G₃ extracted from the multi-valued image G. For clearly of illustration, only nine pixels a(0,0) to a(2,2) are shown in FIG. 43 as the pixels constituting the multi-valued image G, the multi-valued image G actually has a total of M×N pixels, M pixels in the x direction and N pixels in the y direction.

In the example of FIG. 43(a), the pixel value a(0,0) at a position (0,0) is equal to 6 and is expressed as:

a(0,0)=6=0·2³+1·2²+1·2¹+0·2⁰

according to Equation (23).

The respective bit values of the pixel value a(0.0) are thus a₃(0,0)=0, a₂(0,0)=1, a₁(0,0)=1, and a₀(0,0)=0 in this order from the upper bit to the lower bit.

As shown in FIG. 43(b), the value at the position (0,0) in the bit plane G₃ is the bit value a₃(0,0)=0, the value at the position (0,0) in the bit plane G₂ is the bit value a₂(0,0)=1, the value at the position (0,0) in the bit plane G₁ is the bit value a₁(0,0)=1, and the value at the position (0,0) in the bit plane G₀ is the bit value a₀(0,0)=0.

The pixel at the position (0,0) is described above as an example. Similarly bit values a₃(x,y), a₂(x,y), a₁(x,y), and a₀(x,y) are obtained with regard to any arbitrary pixel at a position (x,y), and represent the values at the position (x,y) in the respective bit planes G₃, G₂, G₁, and G₀.

In this manner, the bit plane extraction module 49 extracts the bit planes from the read-out multi-valued image.

The block division module 41 selects a specific bit plane Gₖ among the extracted four bit planes G₃, G₂, G₁, and G₀ and divides the specific bit plane Gₖ into multiple blocks of m×n pixels (step S606). The value k for specifying the specific bit plane Gₖ is hereafter referred to as the specific value.

The pixel number computation module 42 subsequently determines the number of pixels having the bit value ‘1’ (that is, aₖ(x,y)=1) in each divisional block Aᵢ (i=1,2,3, . . . ) (step S608). For convenience of explanation, the pixels having the bit value ‘1’ in the specific bit plane Gₖ are hereafter referred to as the ‘pixels of bit value=1’.

The process (step S300″) subsequent to step S608 is similar to the value variation process (step S300) shown in FIG. 5. The value variation process (step S300″) of this embodiment is thus not described in detail. While the black pixels are the target of the value variation process (step S300) of FIG. 5, the pixels of bit value=1 are the target of the value variation process (step S300″) of this embodiment shown in FIG. 42. In the value variation process (step S300″) of FIG. 42, the ‘black pixels’ and the ‘pixel value’ in the description of the value variation process (step S300) of FIG. 5 should respectively be changed to the ‘pixels of bit value=1’ and the ‘bit value’.

In the value variation process (step S300) of FIG. 5, the pixel varying module 46 varies the pixel value a(x,y) from ‘0’ to ‘1’ in the case of the positive number of changing pixels cᵢ and from ‘1’ to ‘0’ in the case of the negative number of changing pixels cᵢ with regard to the pixels on the edge of each line-work object in the block of interest Aᵢ corresponding to the absolute value |cᵢ| of the number of changing pixels at step S324.

In the value variation process (step S300″) of FIG. 42, on the other hand, the pixel varying module 46 varies the bit value aₖ(x,y) from ‘0’ to ‘1’ in the case of the positive number of changing pixels cᵢ and from ‘1’ to ‘0’ in the case of the negative number of changing pixels cᵢ with regard to the pixels on the edge of each line-work object in the block of interest Aᵢ corresponding to the absolute value |cᵢ| of the number of changing pixels.

The value variation process (step S300″) of FIG. 42 is executed for the specific bit plane Gₖ, so that the watermark information is embedded in the specific bit plane Gₖ.

The bit plane composition module 50 carries out an inverse process to the processing of step S604 and combines data of all the four bit planes including the specific bit plane Gₖ, in which the watermark information is embedded, to restore the multi-valued image data (step S610).

The program then exits from the digital watermark embedding routine of FIG. 42.

The digital watermark embedding process of this embodiment enables the watermark information representing copyright information to be embedded into the multi-valued image data representing a cartoon. Among the various parameters used in the digital watermark embedding process, the block size (m pixels by n pixels) and the reference value p are the secret keys in the first and the second embodiments. This embodiment additionally sets the specific value k for specifying the bit plane in which the watermark information is embedded, as the secret key.

The above description does not specifically refer to which of multiple bit planes constituting a multi-valued image is to be selected as the specific bit plane. In order to prevent deterioration of the picture quality, it is preferable to select a bit plane of a relatively low bit as the specific bit plane, and most preferable to select the bit plane of the lower most bit.

Here it is assumed that a bit plane of an upper bit (for example, G₃ or G₂ in FIG. 43(b)) is selected as the specific bit plane. The variation in bit value aₖ(x,y) of a pixel in the process of embedding the watermark information has a significantly greater effect on the pixel value a(x,y) of the pixel in the bit plane of the upper bit, compared with in a bit plane of a lower bit (for example, G₁ or G₀ in FIG. 43(b)).

In the case of 4-bit multi-valued image data, the pixel value of a pixel is expressed by 4 bits. When the pixel value of the pixel is ‘1111’, a variation in bit value of the lower most bit among the four bits to ‘0’ changes the pixel value of the pixel to ‘1110’. This is no significant change. A variation in bit value of the upper most bit to ‘0’, on the other hand, changes the pixel value of the pixel to ‘0111’. This is a significant change.

Selection of the bit plane of the relatively low bit as the specific bit plane has less effect on the pixel value and thus more effectively prevents the deterioration of the picture quality. Most preferable is selection of the bit plane of the lower most bit as the specific bit plane.

I-2. Modification of Digital Watermark Embedding Process

In the above embodiment, there is only one specific bit plane, in which the watermark information is to be embedded. There may be, however, multiple specific bit planes. All the bit planes constituting a multi-valued image may be selectable as specific bit planes. Selection of multiple specific bit planes increases the quantity of embeddable information.

Similar modifications to those discussed previously as the first and the second modifications of the digital watermark embedding process of the second embodiment are also applicable to the digital watermark embedding process of the third embodiment.

I-3. Digital Watermark Extraction Process

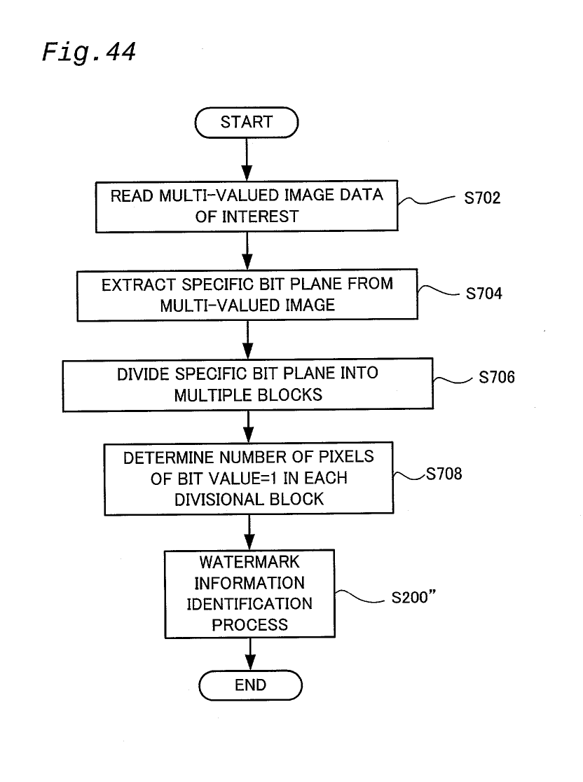

FIG. 44 is a flowchart showing a routine of the digital watermark extraction process executed in the fifth embodiment of the present invention. This routine is executed by the block division module 41, the pixel number computation module 42, the block decision module 43, the operation module 44, the information identification module 47, the bit plane extraction module 49, and the bit plane composition module 50 shown in FIG. 1.

In this embodiment, multi-valued image data with watermark information embedded therein by the digital watermark embedding process shown in FIG. 42 is stored in advance as image data of interest in the hard disk unit 36.

When the program enters the digital watermark extraction routine shown in the flowchart of FIG. 44, the bit plane extraction module 49 first reads multi-valued image data of interest from the hard disk unit 36 (step S702). The bit plane extraction module 49 then obtains a specific value k representing a bit plane, in which watermark information is embedded, from the information of secret keys used in the process of embedding the watermark information into the multi-valued image data, and extracts a specific bit plane Gₖ from the multi-valued image (step S704).

The block division module 41 divides the extracted specific bit plane Gₖ into multiple blocks of m×n pixels (step S706). The pixel number computation module 42 subsequently determines the number of pixels having the bit value ‘1’, that is, the pixels of bit value=1, in each divisional block Aᵢ (i=1,2,3, . . . ) (step S708).

The process (step S200″) subsequent to step S708 is similar to the watermark information identification process (step S200) shown in FIG. 4. The details of step S200″ are thus not specifically described here. While the black pixels are the target of the watermark information identification process (step S200) of FIG. 4, the pixels of bit value=1 are the target of the watermark information identification process (step S200″) of this embodiment shown in FIG. 44. In the watermark information identification process (step S200″) of FIG. 44, the ‘black pixels’ in the description of the watermark information identification process (step S200) of FIG. 4 should be changed to the ‘pixels of bit value=1’.

The watermark information identification process (step S200″) enables the embedded watermark information dᵢ to be extracted from each embeddable block of the specific bit plane.

The digital watermark extraction process described above extracts the watermark information embedded in the multi-valued image data representing a cartoon and takes out the copyright information of the cartoon. This procedure of the embodiment does not require an original image but enables extraction of the embedded watermark information with the secret keys.

In this embodiment, the number of blocks E′ determined as embeddable blocks at the time of extracting watermark information may not be coincident with the number of blocks E determined as embeddable blocks at the time of embedding watermark information, due to noise and malicious attacks by any third person.

J. Modifications

The above embodiments and their modifications are to be considered in all aspects as illustrative and not restrictive. There may be many other modifications, changes, and alterations without departing from the scope or spirit of the main characteristics of the present invention.

J-1. First Modification

In the third through the fifth embodiments described above, the luminance component y and the bit value are varied to make a random distribution of the residual by the reference value p in the process of embedding watermark information, as in the case of the second embodiment. One modified procedure may vary the luminance component y and the bit value to make a fixed residual by the reference value p as in the case of the first embodiment.

J-2. Second Modification

In the respective embodiments described above, the predetermined operation calculates the residual of the number of pixels by the reference value p. The technique of the present invention is, however, not restricted to this operation, but may utilize a diversity of operations by combining addition, subtraction, multiplication, division, integration, differentiation, and other functional operations.

J-3. Third Modification

The procedures of the first and the second embodiments compute the number of black pixels and calculate the residual of the number of black pixels by the reference value p. One modified procedure may compute the number of white pixels and calculate the residual of the number of white pixels.

J-4. Fourth Modification

The procedure of the third embodiment specifies the threshold value γ, computes the number of pixels having the luminance component y fulfilling Conditional Expression (21) y<γ (low luminance pixels), and calculates the residual of the number of low luminance pixels by the reference value p. One modified procedure may compute the number of pixels having the luminance component y fulfilling another conditional expression y≧γ and calculate the residual of the number of such pixels. Another modified procedure may specify two threshold values (γ1 and γ2), compute the number of pixels having the luminance component y fulfilling another conditional expression γ1≦y<γ2 or still another conditional expressions y<γ1 and γ2≦y, and calculate the residual of the number of such pixels. The number of threshold values may be 3, 4, or more.

J-5. Fifth Modification

The procedure of the third embodiment utilizes the luminance component for embedding watermark information. One modified procedure may utilize a color component for embedding watermark information.

J-6. Sixth Modification

In the third and the fourth embodiments described above, the color image of interest as the object of embedding is a color image in the RGB color system. The color image of interest may alternatively be a color image in another color system, for example, the CMY color system. Although the procedure of the third embodiment converts the color image into the YC_{b}Cᵣ color system, the color image may be converted into another color system, such as the XYZ color system.

J-7. Seventh Modification

The above description does not specifically refer to the method of storing the secret keys. One applicable procedure may encode the secret keys and embed the encoded secret keys into image data according to another digital watermark embedding process.

What is claimed is:

1. A digital watermark embedding method for embedding watermark information in image data, the digital watermark embedding method comprising the steps of:
(a) dividing the image data into multiple blocks, where each of the multiple blocks includes at least one pixel;
(b) computing a number of specific pixels that have a specific value fulfilling a predetermined condition, out of all pixels included in each of the multiple blocks;
(c) making the computed number of specific pixels subjected to a preset operation; and
(d) changing the specific value of at least one pixel included in each block in such a manner that a resulting value obtained by the preset operation satisfies a certain condition corresponding to a piece of information to be embedded in the block, among a plurality of conditions set in advance in mapping to the watermark information.

2. A digital watermark embedding method in accordance with claim 1, the digital watermark embedding method further comprising the step of:
(e) determining whether or not the watermark information is to be embedded in each block, based on the computed number of specific pixels,
wherein the steps (c) and (d) are executed for only a block determined in the step (e) that the watermark information is to be embedded.

3. A digital watermark embedding method in accordance with claim 1, wherein the watermark information is expressed by at least a binary value including a first value and a second value,
the step (d) changing the specific value of the pixel, when the piece of information to be embedded in the block is the first value, to satisfy such a condition that the resulting value of the preset operation is in a first range as the certain condition corresponding to the first value and, when the piece of information to be embedded in the block is the second value, to satisfy such a condition that the resulting value of the preset operation is in a second range, which is different from the first range, as the certain condition corresponding to the second value.

4. A digital watermark embedding method in accordance with claim 3, wherein the step (d) comprises the step of generating a random value,
the step (d) changing the specific value of the pixel, when the piece of information is the first value, to make the resulting value of the preset operation equal to a value corresponding to the random value among values included in the first range and, when the piece of information is the second value, to make the resulting value of the preset operation equal to a value corresponding to the random value among values included in the second range.

5. A digital watermark embedding method in accordance with claim 3, wherein the step (d) changes the specific value of the pixel, when the piece of information is the first value, to make the resulting value of the preset operation equal to a third value included in the first range and, when the piece of information is the second value, to make the resulting value of the preset operation equal to a fourth value included in the second range.

6. A digital watermark embedding method in accordance with claim 1, wherein the image data is binary image data including a pixel value expressed by either one of a fifth value and a sixth value, the pixel value is used for the specific value of the pixel, and
the step (b) computes the number of specific pixels fulfilling the predetermined condition that the pixel value is equal to the fifth value.

7. A digital watermark embedding method in accordance with claim 1, wherein the image data is color image data, the specific value of the pixel is a value of a luminance component of the pixel, and
the step (b) computes the number of specific pixels fulfilling the predetermined condition that the value of the luminance component of the pixel is in a preset third range.

8. A digital watermark embedding method in accordance with claim 1, wherein the image data is color image data, the specific value of the pixel is a color vector of the pixel, and
the step (b) computes the number of specific pixels fulfilling the predetermined condition that the color vector is a specified color vector.

9. A digital watermark embedding method in accordance with claim 8, wherein the step (b) varies at random the specific color vector as the predetermined condition for each of the multiple blocks.

10. A digital watermark embedding method in accordance with claim 2, wherein the image data is color image data, the specific value of the pixel is a color vector of the pixel, and
the step (b) computes the number of specific pixels fulfilling the predetermined condition that the color vector is a specified color vector.

11. A digital watermark embedding method in accordance with claim 10, wherein the step (b) varies at random the specific color vector as the predetermined condition for each of the multiple blocks.

12. A digital watermark embedding method in accordance with claim 3, wherein the image data is color image data, the specific value of the pixel is a color vector of the pixel, and
the step (b) computes the number of specific pixels fulfilling the predetermined condition that the color vector is a specified color vector.

13. A digital watermark embedding method in accordance with claim 12, wherein the step (b) varies at random the specific color vector as the predetermined condition for each of the multiple blocks.

14. A digital watermark embedding method in accordance with claim 4, wherein the image data is color image data, the specific value of the pixel is a color vector of the pixel, and
the step (b) computes the number of specific pixels fulfilling the predetermined condition that the color vector is a specified color vector.

15. A digital watermark embedding method in accordance with claim 14, wherein the step (b) varies at random the specific color vector as the predetermined condition for each of the multiple blocks.

16. A digital watermark embedding method in accordance with claim 5, wherein the image data is color image data, the specific value of the pixel is a color vector of the pixel, and
the step (b) computes the number of specific pixels fulfilling the predetermined condition that the color vector is a specified color vector.

17. A digital watermark embedding method in accordance with claim 16, wherein the step (b) varies at random the specific color vector as the predetermined condition for each of the multiple blocks.

18. A digital watermark embedding method in accordance with claim 1, wherein the image data is multi-valued image data, the specific value of the pixel is a certain bit value in a pixel value, and
the step (b) computes the number of specific pixels fulfilling the predetermined condition that the certain bit value is equal to ‘1’ or the number of specific pixels fulfilling the predetermined condition that the certain bit value is equal to ‘0’.

19. A digital watermark extraction method for extracting embedded watermark information from image data, the digital watermark extraction method comprising the steps of:
(a) dividing the image data into multiple blocks, where each of the multiple blocks includes at least one pixel;
(b) computing a number of specific pixels that have a specific value fulfilling a predetermined condition, out of all pixels included in each of the multiple blocks;
(c) making the computed number of specific pixels subjected to a preset operation; and
(d) determining which of a plurality of conditions set in advance in mapping to the watermark information is satisfied by a resulting value of the preset operation, and specifying a piece of information corresponding to the satisfied condition as the watermark information embedded in the block.

20. A digital watermark embedding apparatus for embedding watermark information in image data, the digital watermark embedding apparatus comprising:
a block division module that divides the image data into multiple blocks, where each of the multiple blocks includes at least one pixel;
a pixel number computation module that computes a number of specific pixels that have a specific value fulfilling a predetermined condition, out of all pixels included in each of the multiple blocks;
an operation module that makes the computed number of specific pixels subjected to a preset operation; and
a pixel value changing module that changes the specific value of at least one pixel included in each block in such a manner that a resulting value obtained by the preset operation satisfies a certain condition corresponding to a piece of information to be embedded in the block, among a plurality of conditions set in advance in mapping to the watermark information.

21. A digital watermark extraction apparatus for extracting embedded watermark information from image data, the digital watermark extraction apparatus comprising:
a block division module that divides the image data into multiple blocks, where each of the multiple blocks includes at least one pixel;
a pixel number computation module that computes a number of specific pixels that have a specific value fulfilling a predetermined condition, out of all pixels included in each of the multiple blocks;
an operation module that makes the computed number of specific pixels subjected to a preset operation; and
a watermark information specification module that determines which of a plurality of conditions set in advance in mapping to the watermark information is satisfied by a resulting value of the preset operation, and specifies a piece of information corresponding to the satisfied condition as the watermark information embedded in the block.

22. A computer program product for embedding watermark information in image data, the computer program product comprising:
a first program code of dividing the image data into multiple blocks, where each of the multiple blocks includes at least one pixel;
a second program code of computing a number of specific pixels that have a specific value fulfilling a predetermined condition, out of all pixels included in each of the multiple blocks;
a third program code of making the computed number of specific pixels subjected to a preset operation;
a fourth program code of changing the specific value of at least one pixel included in each block in such a manner that a resulting value obtained by the preset operation satisfies a certain condition corresponding to a piece of information to be embedded in the block, among a plurality of conditions set in advance in mapping to the watermark information; and
a computer readable medium in which the program codes are recorded.

23. A computer program product for extracting embedded watermark information from image data, the computer program product comprising:
a first program code of dividing the image data into multiple blocks, where each of the multiple blocks includes at least one pixel;
a second program code of computing a number of specific pixels that have a specific value fulfilling a predetermined condition, out of all pixels included in each of the multiple blocks;
a third program code of making the computed number of specific pixels subjected to a preset operation;
a fourth program code of determining which of a plurality of conditions set in advance in mapping to the watermark information is satisfied by a resulting value of the preset operation, and specifying a piece of information corresponding to the satisfied condition as the watermark information embedded in the block; and
a computer readable medium in which the program codes are recorded.
